(19) United States
(12) Patent Application Publication
(10) Pub. No.: US 2002/0065785 A1
(43) Pub. Date: May 30, 2002

(54) Mobile communication system using mobile IP and AAA protocols for general authentication and accounting

(75) Inventor: Yoshiyuki Tsuda, Kanagawa (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: KABUSHIKI KAISHA TOSHIBA, Tokyo (JP)

(21) Appl. No.: 09/994,013

(22) Filed: Nov. 27, 2001

(30) Foreign Application Priority Data
Nov. 28, 2000 (JP) 2000-361435

(51) Int. Cl. G06F 17/60

(52) U.S. Cl. 705/67

(57) ABSTRACT

In a mobile communication system, a mobile node device according to Mobile IP protocol transmits an authentication and accounting request for requesting a desired accounting service at an AAAH server device according to a prescribed AAA protocol which is provided at a home network of the mobile node device. Then, the AAAH server device carries out a processing for providing the desired accounting service according to the authentication and accounting request.

### BACKGROUND OF THE INVENTION

1. Field of the Invention

The present invention relates to a mobile communication system containing mobile node devices according to the Mobile IP protocol and an AAA server device for supporting the mobile node devices according to the AAA protocol.

2. Description of the Related Art

As a conventional authentication and accounting system for mobile nodes, there is an authentication and accounting system proposed by the IETF AAA working group. This authentication and accounting system adopts a DIAMETER protocol (see the Internet draft “draft-calhoun-diameter-mobileip-09.txt”, July, 2000) as the AAA (Authentication, Authorization and Accounting) protocol and uses an AAA server having AAA functions, to carry out processings for authentication and accounting with respect to mobile nodes according to the IETF Mobile IP protocol (RFC-2002). An example of the systems that are planning to use the AAA protocol for the authentication and accounting processes is the North American third generation wireless system (3GPP2).

However, the authentication and accounting system proposed so far has been the authentication and accounting system for carrying out the accounting with respect to packet communications themselves, so that it has been impossible to utilize it for the authentication and accounting for the other needs that may arise on the mobile nodes.

Next, with reference to FIG. 23, the conventional IP telephone system will be described.

In the conventional IP telephone system, when a user on an IP terminal (user terminal) 2901 starts communications using the IP telephone with a desired correspondent, if the host name and/or the IP address of an IP terminal (correspondent terminal) 2903 used by the correspondent are known, it is possible to directly send a call set up request to the correspondent IP terminal 2903 by using that host name and/or IP address.

Also, if the host name and the IP address of the IP terminal 2903 used by the desired correspondent are not known, it has been possible to use a directory server 2902 shown in FIG. 23, for example, to carry out a search by using a name of the correspondent (a surname of the correspondent, for example) as a key to find out the host name and/or the IP address of the IP terminal 2903 used by the correspondent, and send a call setup request to the IP terminal 2903 used by the correspondent by using the search result.

Moreover, if the IP terminal 2903 used by the desired correspondent is a mobile node capable of receiving a service of the IETF Mobile IP protocol and if a home IP address at a home network of the IP terminal 2903 of the correspondent is registered in advance on the directory server 2902 as a registration information of the IP terminal 2903 of the correspondent, even in the case where the IP terminal 2903 of the correspondent is located at a visited network rather than a home network, the call setup request transmitted to that home IP address can reach the IP terminal 2903 at the visited network. Namely, the registration information of the IP terminal 2903 used by the correspondent can be ascertained as a result of the search using the directory server 2902, and the call setup request packet transmitted to that home IP address will be forwarded to the target IP terminal located at the visited network via a home agent of the home network of the IP terminal 2903 according to the mobility supporting mechanism by the Mobile IP.

However, the above described method for searching the correspondent terminal using the directly server only provides a command based interface, which is rather difficult to understand for the general users.

For this reason, in order to provide an interface that is easy to understand for the general users, the following method has been proposed, In this method, an icon is created on a WWW page, for example, and a host name is specified as its URL in such a manner as:

sipp:://host.network.com for example, in advance. Then, when a user simply clicks the above icon, a SIP (Session Initiation Protocol, RFC-2543) on the user terminal is activated and the call setup request packet can be transmitted to the IP terminal of the host name (“host.network.com” in this example) specified by the URL, so that it is possible to provide an interface which is easy to understand even for the general users.

However, in the case where the correspondent terminal is a mobile node using the Mobile IP, even if the icon as described above is created on the WWW page, it is impossible to recognize whether the correspondent terminal is in a state capable of carrying out communications by using the Mobile IP or in a state of not capable of carrying out communications as it is not connected to a network, by simply looking at the icon, so that an interface that is really easy to understand for the users cannot necessarily be realized.

Also, in the case of using the Mobile IP, a life time is set for a visited IP address (care-of address) registered by a registration request made from a mobile node to its home agent, but there is no guarantee that this mobile node will remain at the registered visited IP address until the life time is over and there is a possibility for this mobile node to move to another IP address before the life time is over.

Consequently, there can be cases where this mobile node has already moved to another IP address before the life time is over and the registered IP address is used by another terminal different from this mobile node. In such a case, if the call setup request is transmitted to the registered IP address, the call setup request would reach to another terminal for which it is not intended and cause the problem.

As described, the conventional authentication and accounting system applied to the terminal using the Mobile IP is a system designed for carrying out the authentication and accounting for packet communications, and could not be used for the authentication and accounting for the other purposes such as the authentication and accounting that occur on the mobile node (the authentication and account for credit payment of charges for purchases, for example).

Also, in the conventional system in which the icon is created on a WWW page such that the IP telephone can be used by simply clicking the icon, when the correspondent terminal is a terminal using the Mobile IP, it has been impossible to ascertain whether the correspondent terminal is in a state capable of carrying out communications by using the Mobile IP or in a state of not capable of carrying out communications.

Also, when the correspondent terminal is a terminal using the Mobile IP, the correspondent terminal may not necessarily be using the registered IP address until the life time is over after the visited IP address is registered, and there is a possibility of the moving before the life time is over. Moreover, if the registered IP address is used by another terminal after the correspondent terminal has moved, the call setup request would be sent to another terminal incorrectly.

### BRIEF SUMMARY OF THE INVENTION

It is therefore an object of the present invention to provide a mobile communication system using an authentication and accounting scheme in which mobile node devices according to the Mobile IP protocol can utilize authentication and accounting services provided by AAA servers according to a prescribed AAA protocol for various purposes.

It is another object of the present invention to provide a mobile node device information providing method capable of providing information regarding a state of a mobile node device according to the Mobile IP protocol.

It is another object of the present invention to provide a correspondent terminal checking method capable of checking a correspondent terminal prior to a call setup procedure even when the correspondent terminal is a mobile node device according to the Mobile IP protocol.

According to one aspect of the present invention there is provided a mobile communication system, comprising: a mobile node device according to Mobile IP protocol; an AAAH server device according to a prescribed AAA protocol which is provided at a home network of the mobile node device, for supporting an authentication and accounting service with respect to packet communications by the mobile node device; the mobile node device having a transmission unit configured to transmit an authentication and accounting request for requesting a desired accounting service at the AAAH server device; and the AAAH server device having: an information recording unit configured to record communication fee information regarding a communication fee to be charged to a user of the mobile node device; and a processing unit configured to carry out authentication and accounting processes for the packet communications by the mobile node device according to the communication fee information, and a processing for providing the desired accounting service according to the authentication and accounting request which is received from the mobile node device when it is judged that authentication succeeded according to authentication information contained in the authentication and accounting request.

According to another aspect of the present invention there is provided a mobile node device according to Mobile IP protocol, comprising: a Mobile IP processing unit configured to carry out a procedure for receiving a packet transfer service according to the Mobile IP by a home agent device provided at a home network of the mobile node device and a foreign agent device provided at a visited network of the mobile node device; and an AAA processing unit configured to carry out a procedure for receiving a desired accounting service, with respect to an AAAH server device according to a prescribed AAA protocol which is provided at the home network for managing information regarding a communication fee of the mobile node device, while receiving the packet transfer service at the Mobile IP processing unit.

According to another aspect of the present invention there is provided an AAAH server device according to a prescribed AAA protocol which is provided at a home network of a mobile node device according to Mobile IP protocol in a mobile communication system, for supporting an authentication and accounting service with respect to packet communications by the mobile node device, the AAAH server device comprising: an information recording unit configured to record communication fee information regarding a communication fee to be charged to a user of the mobile node device; and a processing unit configured to carry out authentication and accounting processes for the packet communications by the mobile node device according to the communication fee information, and a procedure for providing a desired accounting service according to an authentication and accounting request which is received from the mobile node device when it is judged that authentication succeeded according to authentication information contained in the authentication and accounting request.

According to another aspect of the present invention there is provided a method for receiving an authentication and accounting service at a mobile node device according to Mobile IP protocol, the method comprising: carrying out a procedure for receiving a packet transfer service according to the Mobile IP by a home agent device provided at a home network of the mobile node device and a foreign agent device provided at a visited network of the mobile node device; and carrying out a procedure for receiving a service of a desired accounting service, with respect to an AAAH server device according to a prescribed AAA protocol which is provided at the home network for managing information regarding a communication fee of the mobile node device, while receiving the packet transfer service.

According to another aspect of the present invention there is provided a method for providing an authentication and accounting service at an AAAH server device according to a prescribed AAA protocol which is provided at a home network of a mobile node device according to Mobile IP protocol in a mobile communication system, for supporting an authentication and accounting service with respect to packet communications by the mobile node device, the method comprising: recording communication fee information regarding a communication fee to be charged to a user of the mobile node device; and carrying out authentication and accounting processes for the packet communications by the mobile node device according to the communication fee information, and a procedure for providing a desired accounting service according to an authentication and accounting request which is received from the mobile node device when it is judged that authentication succeeded according to authentication information contained in the authentication and accounting request.

According to another aspect of the present invention there is provided a method for providing a mobile node device information, comprising: notifying information indicating a state of a mobile node device according to Mobile IP protocol from a prescribed server device which detected the state of the mobile node device to a WWW server device for providing information of the mobile node device; and updating a display format of a prescribed display content corresponding to the mobile node device to a new display format corresponding to a notified state at a WWW page corresponding to the mobile node device provided by the WWW server device upon receiving the information indicating the state of the mobile node device.

According to another aspect of the present invention there is provided a method for confirming a correspondent terminal, comprising: transmitting a confirmation request from a first terminal device to a second terminal device which is a mobile node device according to Mobile IP protocol, before carrying out a call setup procedure from the first terminal device with respect to the second terminal device, the confirmation request containing an identification information including a host name or a set of a host name and a user name of the second terminal device as recognized by the first terminal device; comparing the identification information contained in the confirmation request with an actual identification information including an actual host name or a set of an actual host name and an actual user name of the second terminal device, at the second terminal device upon receiving the confirmation request, and returning an affirmative response when the identification information contained in the confirmation request coincides with the actual identification information of the second terminal device or a negative response when the identification information contained in the confirmation request does not coincide with the actual identification information of the second terminal device, from the second terminal device to the first terminal device; and carrying out the call setup procedure from the first terminal device with respect to the second terminal device when the affirmative response from the second terminal device is received at the first terminal device.

Other features and advantages of the present invention will become apparent from the following description taken in conjunction with the accompanying drawings.

### BRIEF DESCRIPTION OF THE DRAWINGS

FIG. 1 is a schematic diagram showing one exemplary configuration of a communication system according to the first embodiment of the present invention.

FIG. 2 is a block diagram showing an exemplary configuration of a mobile node in the communication system of FIG. 1.

FIG. 3 is a block diagram showing an exemplary configuration of an AAAH server in the communication system of FIG. 1.

FIG. 4 is a diagram showing an exemplary configuration of an account database stored in an account database memory unit of the AAAH server shown in FIG. 3.

FIG. 5 is a block diagram showing an exemplary configuration of an AAAF server in the communication system of FIG. 1.

FIG. 6 is a flow chart showing an exemplary processing procedure of a mobile node when a request occurs in the communication system of FIG. 1.

FIG. 7 is a flow chart showing an exemplary processing procedure of an AAAH server when a request is received in the communication system of FIG. 1.

FIG. 8 is a flow chart showing an exemplary processing procedure of an AAAH server when an authentication and accounting request is received in the communication system of FIG. 1.

FIG. 9 is a flow chart showing an exemplary processing procedure for a communication fee accounting process by an AAAF server in the communication system of FIG. 1.

FIG. 10 is a schematic diagram for explaining a registration/authentication and accounting operation in the communication system of FIG. 1.

FIG. 11 is a sequence chart showing an exemplary sequence for a registration/authentication and accounting operation in the communication system of FIG. 1.

FIGS. 12A, 12B, 12C and 12D are diagrams showing exemplary IP packet formats used in the communication system of FIG. 1.

FIG. 13 is a schematic diagram for explaining an authentication and accounting service in the communication system of FIG. 1.

FIG. 14 is a schematic diagram for explaining one exemplary authentication and accounting service in the communication system of FIG. 1.

FIG. 15 is a sequence chart showing an exemplary sequence for one exemplary authentication and accounting service of FIG. 14 in the communication system of FIG. 1.

FIG. 16 is a schematic diagram for explaining another exemplary authentication and accounting service in the communication system of FIG. 1.

FIG. 17 is a sequence chart showing an exemplary sequence for another exemplary authentication and accounting service of FIG. 16 in the communication system of FIG. 1.

FIG. 18 is a schematic diagram showing another exemplary configuration of a communication system according to the first embodiment of the present invention.

FIG. 19 is a schematic diagram showing an exemplary configuration of a Mobile IP telephone system according to the second embodiment of the present invention.

FIG. 20 is a flow chart showing an exemplary processing procedure of a home agent or an AAAH server in the Mobile IP telephone system of FIG. 19.

FIG. 21 is a flow chart showing an exemplary processing procedure of terminals in a mobile communication system according to the third embodiment of the present invention.

FIGS. 22A and 22B are schematic diagrams for explaining the operation of a mobile communication system according to the third embodiment of the present invention in two exemplary cases.

FIG. 23 is a schematic diagram for explaining a conventional IP telephone system.

### DETAILED DESCRIPTION OF THE INVENTION

First, the major features of the present invention will be briefly summarized.

In the present invention, a function for carrying out AAA processing such as that for DIAMETER or the like is provided on a mobile node, and the authentication and accounting processes are carried out between the AAA processing function (AAAM) on the mobile node and the AAA processing mechanism (AAAF) at the visited network or between the AAA processing function (AAAM) on the mobile node and the AAA processing mechanism (AAAH) at the home network, by carrying out communications according to the need.

In the present invention, when a credit payment of charges for purchases occurs on the mobile node, for example, the AAA function (AAAM) on the mobile node can carry out the authentication and accounting processes according to the AAA protocol such as DIAMETER, by exchanging messages with the AAA function (AAAF) at the visited network or the AAA function (AAAH) at the home network according to the need. According to the present invention, it becomes possible for the mobile node device according to the Mobile IP protocol to utilize the authentication and accounting services provided by the AAA server devices according to a prescribed AAA protocol for various purposes.

Also, in the present invention, when the mobile node is connected to the visited network, for example, the mobile node transmits a registration request to the home agent or the AAAH server according to the Mobile IP protocol, and the home agent or the AAAH server that received the registration request from the mobile node via a foreign agent or the like accepts the request if it is acceptable, notifies a state update information of the mobile node to a prescribed WWW server.

The WWW server that received the state update information of the mobile node changes a shape of the icon on the corresponding WWW page to the specific shape registered in advance in correspondence to individual state. The registered states of the mobile node can be “at home network”, “at visited network”, “life time over”, for example. Then, when the transfer of the WWW page is requested from a user terminal, for example, the WWW page containing an icon in the changed shape is transmitted to the user terminal, such that this updated icon shape is visible at the WWW browser on the user terminal when the WWW page is updated from the WWW server.

Also, in the present invention, the user terminal has a function for transmitting a packet for requesting the confirmation of a host name (and a user name) to the correspondent terminal before transmitting a call setup request or a data packet to the correspondent terminal, a function for comparing a received host name (and user name) with own host name (and user name) and producing and transmitting a response packet for notifying their coincidence in the case they coincide or their non-coincidence in the case they do not coincide, and a function for transmitting the call setup request or the data packet in the case where the intended host name (and user name) is confirmed or outputting an error message or carry out other appropriate processing in the case where the intended host name (and user name) is not confirmed upon receiving the response packet.

In the present invention, the user terminal transmits a confirmation request packet for the intended host name (and user name) to a desired correspondent terminal in order to check whether that terminal is really the desired correspondent terminal or not before transmitting the call setup request. The terminal that received this confirmation request packet compares the received host name (and user name) with the own host name (and user name), and if they coincide, this terminal returns a confirmation OK packet, or if they do not coincide, this terminal returns a confirmation NG packet. The user terminal can proceed to the call setup request processing to be carried out next only when the confirmation OK packet is received.

(First Embodiment)

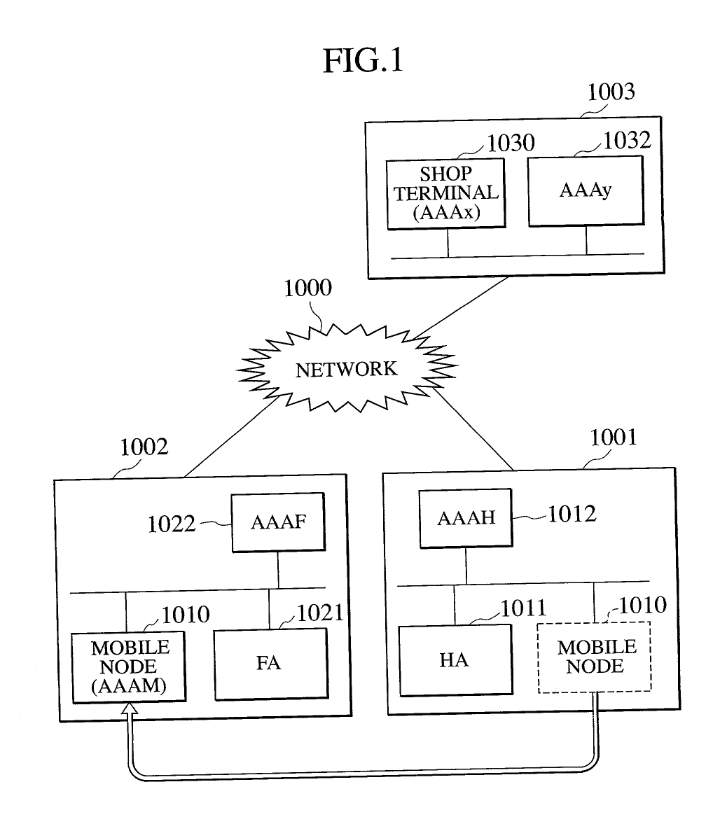

Referring now to FIG. 1 to FIG. 18, the first embodiment of a mobile communication system according to the present invention will be described in detail.

FIG. 1 shows an exemplary network configuration of a communication system according to the first embodiment. This communication system may be one that handles packet transfers for audio and video data or the like, or one that handles the IP telephone or the other application.

In FIG. 1, IP subnets 1001 to 1003 are interconnected through a prescribed network (the Internet, for example). Note that a datalink layer of this network may be formed entirely by wired networks or partially by radio networks. For example, the mobile node can be a portable terminal.

The mobile node 1010 is a terminal having a mobile node function (Mobile IP processing unit) of the Mobile IP using the subnet 1001 as a home network, and a function (AAAM) (AAA processing unit) for receiving the accounting services (such as a service for carrying out a processing for paying a charge to a user of another terminal and a processing for transferring that charge to a bill for own communication fee, etc.) utilizing AAA (DIAMETER or RADIUS, for example).

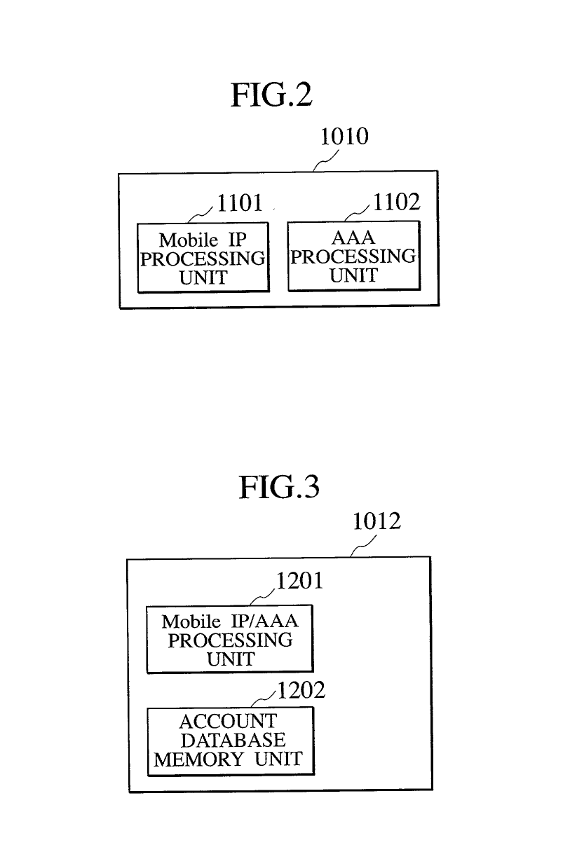

FIG. 2 shows an exemplary configuration of the mobile node 1010. As shown in FIG. 2, the mobile node 1010 has a Mobile IP processing unit 1101 and an AAA processing unit 1102, in addition other elements to be provided according to the need but not shown in the figure such as a TCP/IP communication processing function, a communication interface, a memory device, an input/output device, and a function for executing software necessary in receiving services on the Internet such as a browser software or e-mail software for acquiring information or purchasing goods at electronic shops, for example.

The home agent 1011 is a server having a home agent function of the Mobile IP, which is provided at the subnet 1001.

The AAAH (AAA Home) server 1012 is a server having an AAA function (AAA function at the home network) of the AAA (DIAMETER or RADIUS, for example) for the Mobile IP, which is provided at the subnet 1001.

FIG. 3 shows an exemplary configuration of the AAAH server 1012. As shown in FIG. 3, the AAAH server 1012 has a Mobile IP/AAA processing unit 1201 and an account database memory unit 1202, in addition other elements to be provided according to the need but not shown in the figure such as a TCP/IP communication processing function, a communication interface, a memory device, and an input/output device.

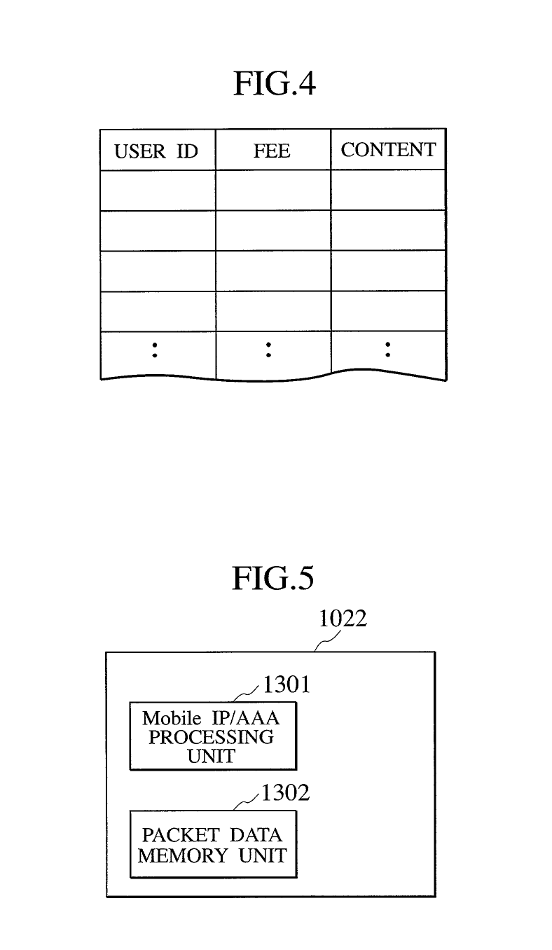

FIG. 4 shows an exemplary configuration of an account database to be stored in the account database memory unit 1202. As shown in FIG. 4, the account database is managed by using a user ID (mobile node) as a key, and contains a user ID corresponding to each mobile node, each incurred fee (a fee to be charged to a user of the user ID), and information regarding the content of that incurred fee (date at which the fee is incurred, a distinction between the communication fee and the transferred charge, the communication content (the communication time, the number of packets, or the number of bytes, for example) in the case of the communication fee, and a payee of the charge to be paid (which may also include information regarding the purchased goods in addition) in the case of the transferred charge). In addition to or instead of the user ID, an identification information for identifying the mobile node may be included, and the content field may describe pointers to data instead of data. Note that the communication fee and the charges for purchases at the electronic shops or the like that are to be transferred to the communication fee will be totalized for each user at each prescribed period of time, and the charging processing (sending a bill, automatically withdrawing from an account, etc.) will be carried out.

The foreign agent 1021 is a server having a foreign agent function of the Mobile IP, which is provided at the subnet 1002.

The AAAF (AAA Foreign) server 1022 is a server having an AAA function (AAA function at the foreign network) of the AAA (DIAMETER or RADIUS, for example) for the Mobile IP, which is provided at the subnet 1002.

FIG. 5 shows an exemplary configuration of the AAAF server 1022. As shown in FIG. 5, the AAAF server 1022 has a Mobile IP/AAA processing unit 1301 and a packet data processing unit 1302, in addition other elements to be provided according to the need but not shown in the figure such as a TCP/IP communication processing function, a communication interface, a memory device, and an input/output device.

The terminal 1030 is a terminal having a function (AAAx) (AAA processing unit) for receiving the accounting services utilizing AAA (DIAMETER or RADIUS, for example), which is a terminal (which may be a server device) connected to the subnet 1003. The terminal 1030 also has other elements to be provided according to the need such as a TCP/IP communication processing function, a communication interface, a memory device, an input/output device, and a function for receiving or providing services on the Internet, for example.

The AAAy server 1032 is a server having an AAA function (AAA function at the home network) of the AAA (DIAMETER or RADIUS, for example) for the Mobile IP, which is provided at the subnet 1003.

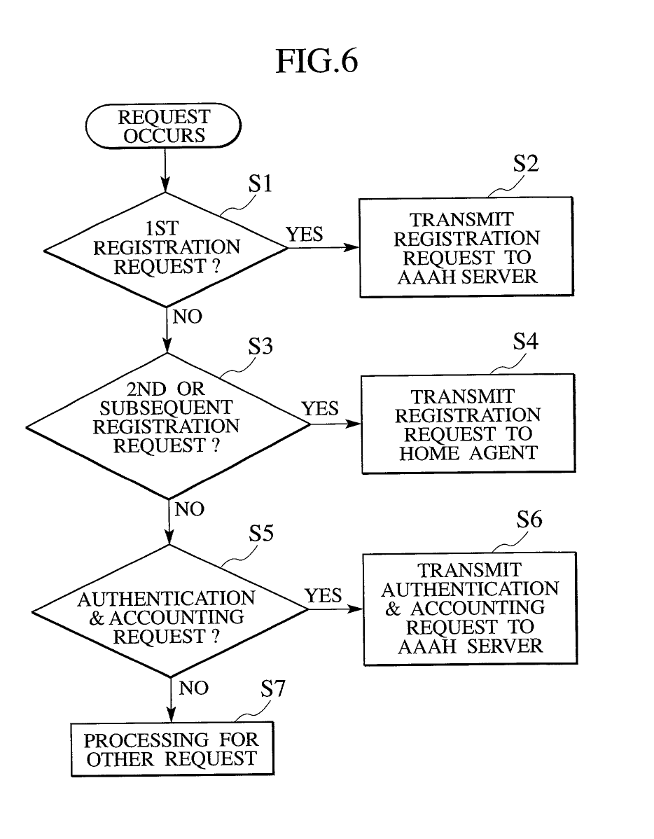

FIG. 6 shows an exemplary processing procedure of the mobile node 1010 when a request occurs. In the case where the occurred request is the first registration request at the subnet to which the mobile node 1010 is connected by roaming through the network (step S1 YES), a registration request packet with the AAAH server 1012 as a final destination is transmitted by the Mobile IP processing unit 1101 (step S2). In the case where the occurred request is the second or subsequent registration request (step S3 YES), a registration packet with the home agent 1011 as the final destination is transmitted by the Mobile IP processing unit 1101 (step S4). In the case where the occurred request is an authentication and accounting request for a desired content (step S5 YES), an authentication and accounting request with the AAAH server 1012 as the final destination is transmitted by the AAA processing unit 1102 (step S6). In the authentication and accounting request packet, information indicating the desired content is described. In other cases, the processing for other occurred request is carried out (step S7).

Note that the mobile node 1010 may be configured such that, upon receiving a response packet corresponding to the request packet transmitted by the mobile node 1010, the mobile node 1010 displays the content of the response packet, and if a user confirmation or selection with respect to the displayed content is necessary, the mobile node 1010 receives the user confirmation or selection and transmits the result of the user confirmation or selection to an appropriate device according to the need.

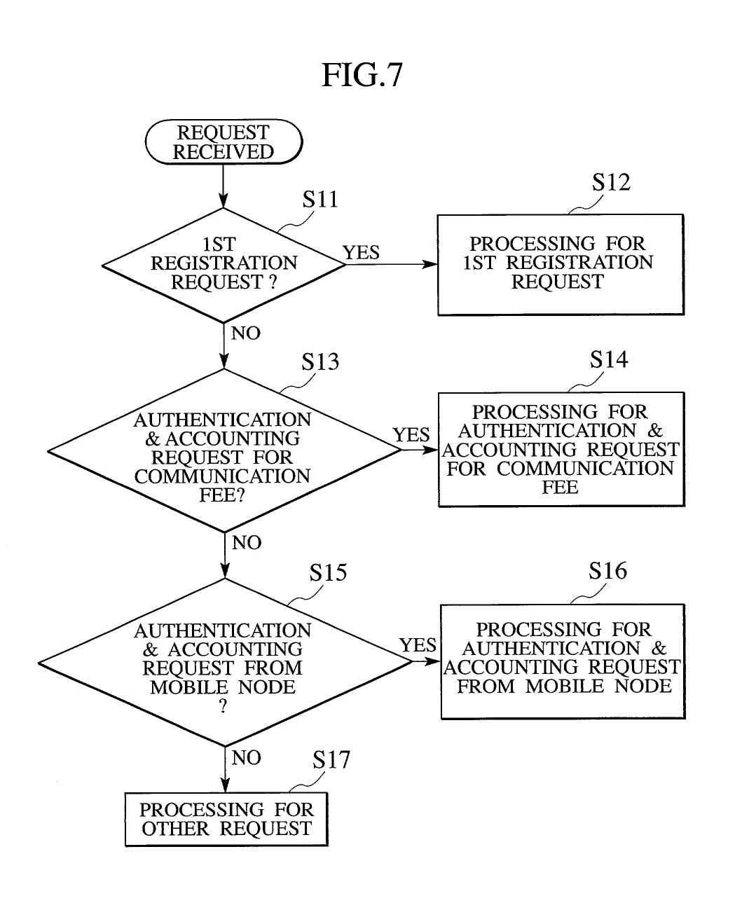

FIG. 7 shows an exemplary processing procedure of the AAAH server 1012 when a request is received. In the case of receiving the registration request packet (for the first registration request) with the mobile node as a source is received (step S11 YES), the processing for the registration request is carried out by the Mobile IP/AAA processing unit 1201 as will be described in detail later (step S12). In the case where an authentication and accounting request packet for the communication fee of the mobile node is received from the AAAF server 1022 (step S13 YES), the necessary information is recorded into the account database memory unit 1202 by the Mobile IP/AAA processing unit 1201 (step S14). In the case where a desired authentication and accounting request packet is received from the mobile node (step S15 YES), a service for that desired request is provided by the Mobile IP/AAA processing unit 1201 through exchanges with the other AAAH server, for example, as will be described in detail later (step S16). In other cases, the processing for the received other request is carried out (step S17).

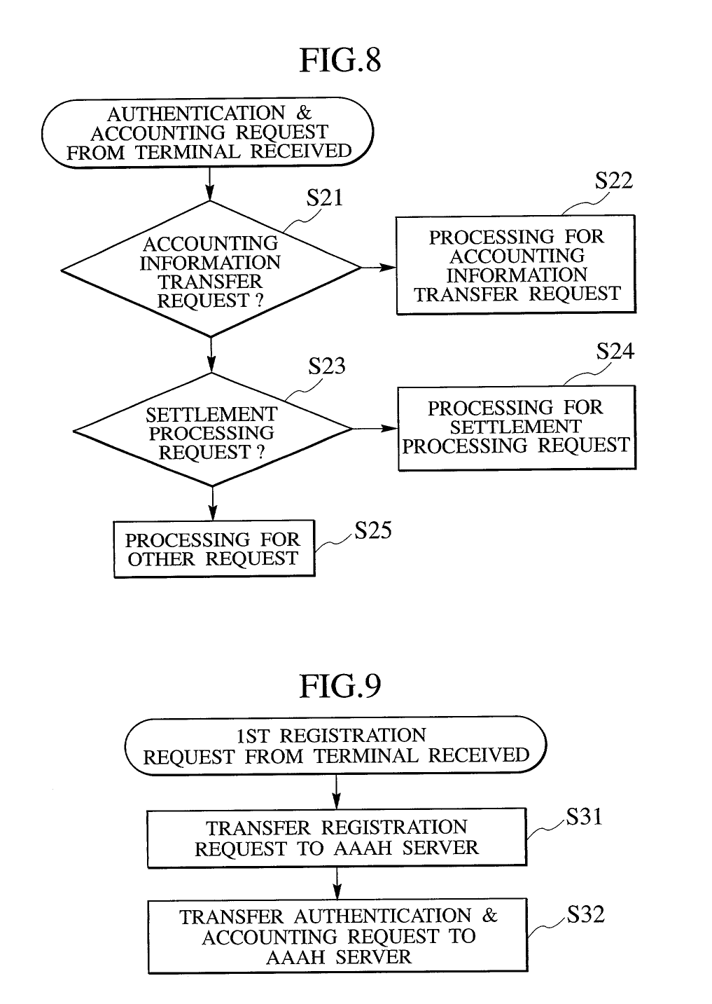

FIG. 8 shows an exemplary processing procedure of the AAAH server 1012 when the desired authentication and accounting request packet is received from the mobile node. In the case where it is a request for acquiring information regarding the accounting, for example (step S21 YES), the accounting information is acquired from the corresponding AAAH server and transmitted to the requesting mobile node (step S22). Also, in the case where it is a request for transferring the charge for the goods purchased at the electronic shop to the communication fee, for example (step S23 YES), the necessary information is recorded into the account database memory unit 1202 and the transfer of the charge for the goods purchase to the communication fee is notified to the other AAAH server (step S24). In the case where it is the other request, the processing for the requested content is carried out (step S25).

The other request can be that for invalidating the corresponding information field recorded in the account database memory unit 1202 upon receiving the settlement cancellation request or the like, in the case of supporting the cancellation, release, or withdrawal after the transfer of the charge for the goods purchased at the electronic shop is transferred to the communication fee.

FIG. 9 shows an exemplary processing procedure of the communication fee accounting process by the AAAF server 1022 with respect to the mobile node. When the registration request packet (for the first registration request) with the mobile node as a source is received, this registration request packet is transferred to the AAAH server 1012, and the recording processing regarding the amount of packet communications (the communication time, the number of packets, the number of bytes, etc.) of the source mobile node is started (step S31). Here, the monitoring of the actual communications is carried out by the foreign agent 1021, and the monitoring result is notified to the AAAF server 1022 (at appropriate interval or after this communication is finished). Then, the AAAF server 1022 transfers the authentication and accounting request packet regarding the communication fee of this mobile node to the AAAH server 1012 (at appropriate interval or after this communication is finished) (step S32).

Now, the existing AAA function is designed for recording the communication fee of the mobile node, but in this embodiment, the AAA function is utilized such that it becomes possible to provide the authentication and accounting service such as a service for transferring the charge to be paid for the purchase of goods to the communication fee when it is requested from the mobile node.

In the following, the terminal 1030 to be the correspondent party of the accounting service with respect to the mobile node 1010 is a terminal or a server (a shop terminal or a shop server) on the provider proding the electronic shop on the Internet, for example. Here, the exemplary case of carrying out the processing for transferring the charge for the goods purchased by the user from the electronic shop to the communication fee, by utilizing the AAA function electronically, will be described. Note that this exemplary case is directed to the case where, in FIG. 1, the terminal 1030 is a fixed terminal, the home network of the mobile node 1010 and the network to which the terminal 1030 belongs are different, and the mobile node 1010 moves to a network different from the network to which the terminal 1030 belongs.

First, the registration request will be described.

When the mobile node 1010 is connected to the visited network 1002, the mobile node 1010 makes the registration request with the AAAH server 1012 as a final destination. By the registration request, the registration procedure according to the Mobile IP is carried out and the procedure for recording the communication fee according to the AAA is carried out. Note that the registration request is made with respect to the AAAH server 1012 (or the home agent 1011) even when the mobile node 1010 is connected after returning from the visited network 1002 to the home network 1001.

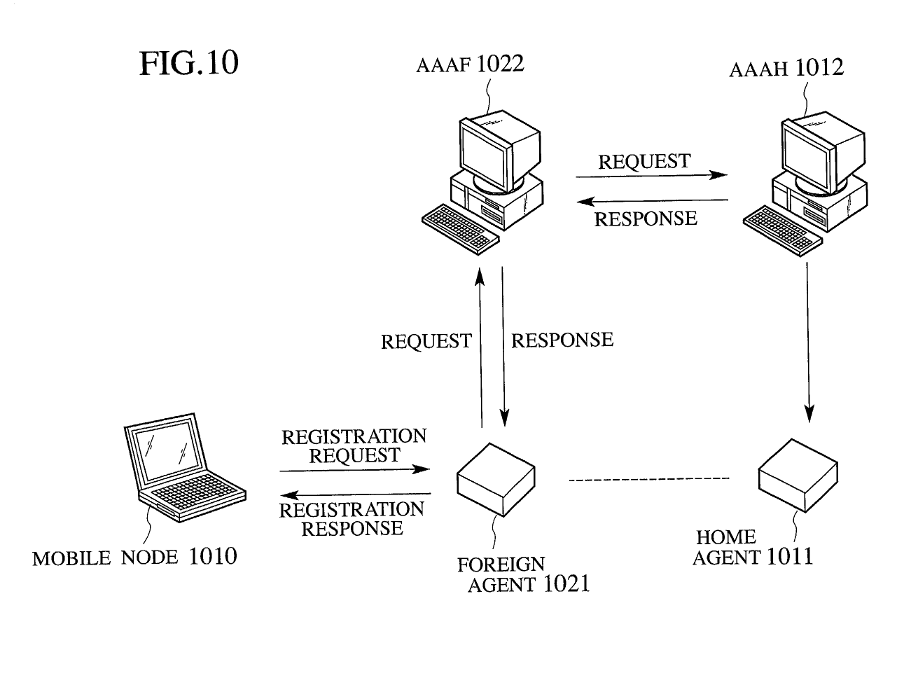

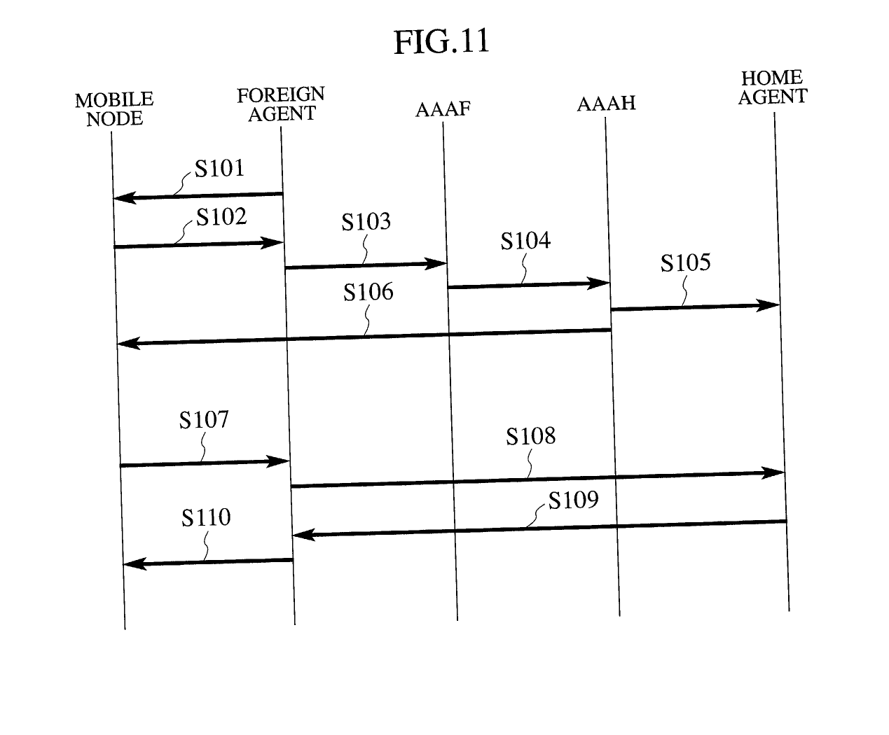

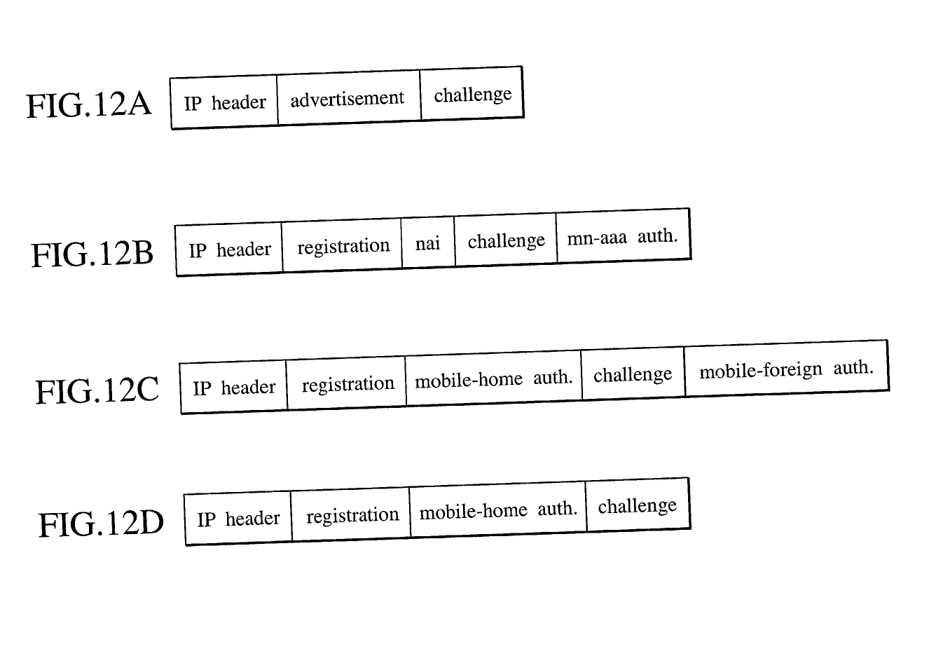

In the following, with references to FIG. 10, FIG. 11 and FIGS. 12A to 12D, the registration of the mobile node 1010 and the authentication and accounting will be described. FIG. 10 shows parts related to the registration request which are extracted from FIG. 1. FIG. 11 shows an exemplary processing procedure for the registration/authentication and accounting. FIGS. 12A to 12D show exemplary IP packet formats to be used in the processing procedure of FIG. 11.

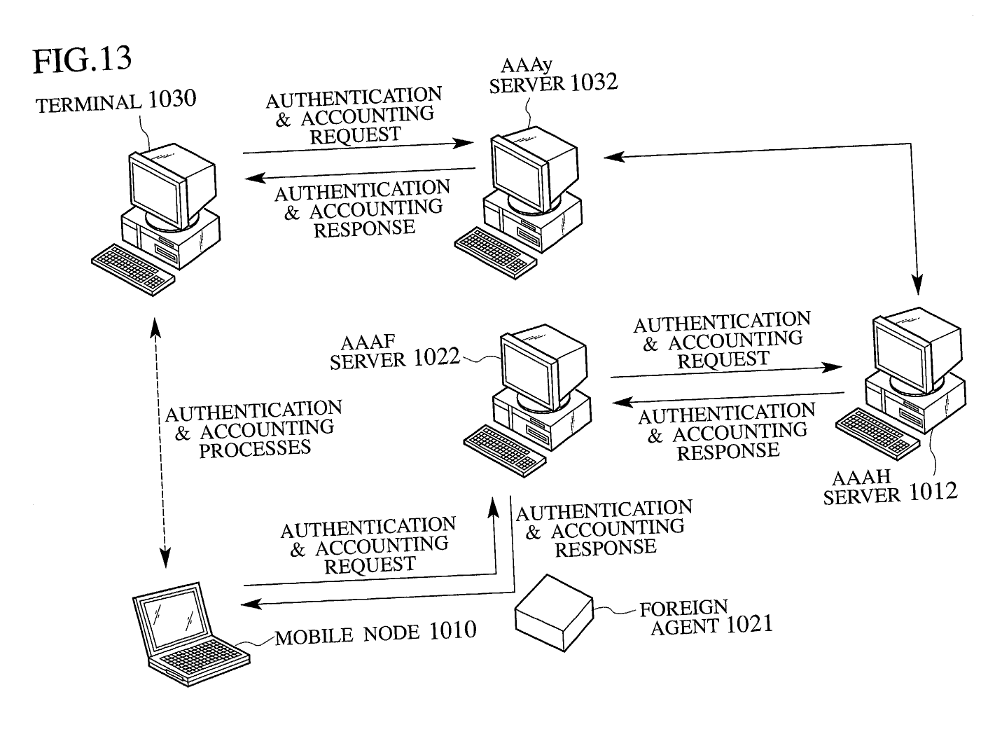

FIG. 12A is a format for an IP packet (that contains IP header, advertisement, and challenge) for the step S101, FIG. 12B is a format for a packet (that contains IP header, registration request information (registration), NAI, challenge, and mn-aaa auth.) for the steps S102 to S104, FIG. 13C is a format for a packet (that contains IP header, registration request information (registration), mobile-home auth., challenge, mobile-foreign auth.) for the steps S107 and S110, and FIG. D is a format for a packet (that contains IP header, registration request information (registration), mobile-home auth., and challenge) for the steps S108 and S109.

Now, the foreign agent 1021 is transmitting an IP packet called advertisement in the Mobile IP protocol with respect to the same subnet periodically (step S101). This advertisement packet has a portion called challenge (a random number is described in the challenge field, for example).

When the mobile node 1010 receives the advertisement packet, this received advertisement packet and the earlier received advertisement packet are compared, and when it is judged that the IP address of the subnet has changed, in order to detect the moving between the subnets and carry out the registration of the Mobile IP protocol, that is, in order to register the care-of address (such as FA (Foreign Agent) care-of address provided by the foreign agent 1021 or the co-located care-of address obtained by the DHCP or the like at the home agent 1011, the mobile node transmits the registration request packet containing that address to the foreign agent 1021 (step S102).

Note that the registration request packet from the mobile node 1010 is assumed to contain an identification information (e-mail address, for example) called NAI (Network Access Identifier), and an mn-aaa authentication expanded portion including the authentication information.

When the foreign agent 1021 receives the above described registration request packet, if it is a new registration request, the foreign agent 1021 inspects the challenge field and checks whether it is the challenge value sent by the foreign agent 1021 itself or not is checked. When it is judged that it is the challenge value sent by the foreign agent 1021 itself, the foreign agent 1021 transmits the above described registration request packet to the AAAF server 1022 for carrying out the authentication and accounting processes regarding the communication fee of that subnet (step S103).

When the AAAF server 1022 receives the above described registration request packet, if it is a new registration request, the AAAF server 1022 creates a new entry, and transfers the above described registration request packet to the AAAH server 1012 (step S104). Note that the AAAF server 1022 can identify the AAAH server 1012 of the home network of the mobile node 1010 from the NAI stored in the registration request packet.

When the AAAH server 1012 receives the above described registration request packet, the AAAH server 1012 checks a portion called MN-AAA auth. of this packet, and when it is judged that the authentication is success as a result of this check, the AAAH server 1012 creates an entry for the mobile node 1010, generates a home IP address to be used by the mobile node 1010, and produces a first key to be used between the mobile node 1010 and the home agent 1011 and a second key to be used between the mobile node 1010 and the foreign agent 1021. Then, the AAAH server 1012 transmits the registration request packet containing the home IP address and the first key to the home agent 1011 (step S105), and returns the registration response packet containing the home IP address, the first key and the second key to the mobile node 1010 (step S106).

The home agent 1011 and the mobile node 1010 carries out the necessary registration and setting according to the above described packets from the AAAH server 1012. In this way, the mobile node 1010 becomes capable of carrying out communications as a mobile node according to the Mobile IP, and the accounting process for the communication fee will be carried out.

Now, in the registration request packet, a life time is described. In order to continue the communication using the Mobile IP, the mobile node 1010 transmits the second or subsequent registration request packet to the home agent 1011 before the life time is over.

For this second or subsequent registration request, the mobile node 1010 produces the registration packet by using the home IP address, the first key to be used with the home agent 1011 and the second key to be used with the foreign agent 1021, that are obtained by the step S106, and transmits this registration request packet to the foreign agent 1021 (step S107).

When the foreign agent 1021 receives the above described second or subsequent registration request packet, the foreign agent 1021 checks a portion called mobile-foreign auth., and when it is judged that the authentication is success as a result of this check, the foreign agent 1021 transmits the registration request packet with the mobile-foreign auth. portion deleted, to the home agent 1011 (step S108).

When the home agent 1011 receives the above described registration request packet, the home agent 1011 checks a portion called mobile-home auth., and when it is judged that the authentication is success as a result of this check, the home agent 1011 extends the life time of the transfer processing using the Mobile IP, produces the registration response packet to which data to be used for the authentication called mobile-home auth. is newly attached, by using the first key to be used between the home agent 1011 and the mobile node 1010, and transfers this registration response packet to the foreign agent 1021 (step S109).

When the foreign agent 1021 receives the above described registration response packet, the foreign agent 1021 produces the registration response packet to which data to be used for the authentication called mobile-foreign auth. is newly attached, by using the second key to be used between the foreign agent 1021 and the mobile node 1010, and transfers this registration response packet to the mobile node 1010 (step S110).

When the mobile node 1010 receives the above described registration response packet, the mobile node 1010 carries out the check of the authentication data at a portion called mobile-home auth. by using the first key to be used with the home agent 1011, and carries out the check of the authentication data at a portion called mobile-foreign auth. by using the second key to be used with the foreign agent 1021. When the checks of the authentication data are success and the response code from the home agent 1011 indicates the success of the registration, the mobile node 1010 recognizes that the registration request is successfully completed.

Note that in the above, if the key is shared in advance between the foreign agent 1021 and the home agent 1011, the authentication data called foreign-home auth. can be attached, or deleted after checking the authentication data, by using that key.

Next, the case where the mobile node requests the authentication and accounting service will be described.

When the registration request is accepted by the procedure as described above, the mobile node 1010 becomes capable of carrying out communications using the Mobile IP.

Here, the exemplary case where the authentication and accounting processes occur between the terminal 1030 and the mobile node 1010 after that will be described. In this case, as shown in FIG. 13 (which has the same configuration as FIG. 1), the AAAH server 1012 is managing the authentication and accounting information of the mobile node 1010, the AAAy server 1032 is managing the authentication and accounting information of the shop, and the authentication and accounting processes are to be carried out between the AAAH server 1012 and the AAAy server 1032.

In outline, the mobile node 1010 first requests (by using a request packet) the AAAH server 1012 to carry out the authentication and accounting processes with respect to the AAAy server 1032, either directly or via the AAAF server 1022 (FIG. 13 shows the case of requesting via the AAAF server 1022), by using the AAA function (AAA processing unit 1102) on the mobile node 1010. The AAAH server 1012 that received this request exchanges messages with the AAAy server 1032 to carry out the authentication and accounting processes. When the authentication and accounting processes are finished, the processing result is notified from the AAAH server 1012 either directly or via the AAAF server 1022 to the AAA function on the mobile node 1010, so that the user can confirm the result. in addition, the processing result is also notified from the AAAy server 1032 to the AAA function on the shop side, so that the shop side can also confirm the result.

Note that, in the example described above, the AAA processing unit 1102 of the mobile node 1010 may fully support the AAA function of the DIAMETER or the like as the AAA function, or partially support only a part of the AAA function for requesting the authentication and accounting processes or displaying the result.

Also, in the above, the authentication and accounting information of the shop is managed by the AAAy server 1032, and there can be cases where the AAAy server 1032 is the same server as the AAAH server 1012, as well as cases where the AAAy server 1032 is the same server as the AAAF server 1022.

Also,in the above, there can be cases where the terminal 1030 of the shop is the same server as the AAAy server 1032. There can also be cases where the terminal 1030 on the shop side is a mobile node. In this case, the terminal 1030 of the shop will have the Mobile IP function and the AAA function similarly as the mobile node 1010.

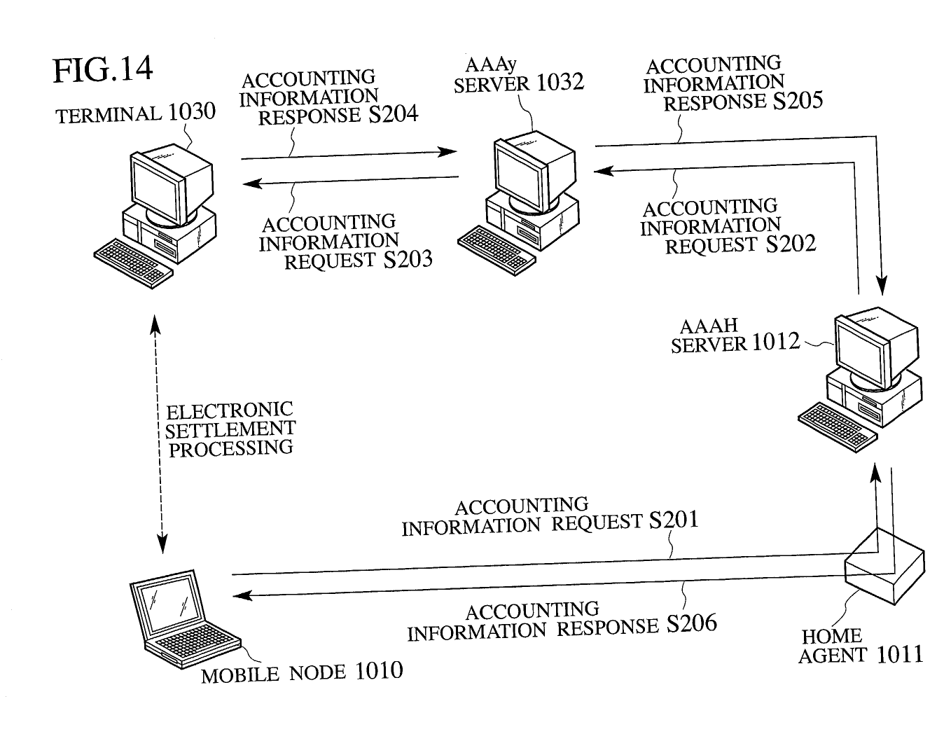

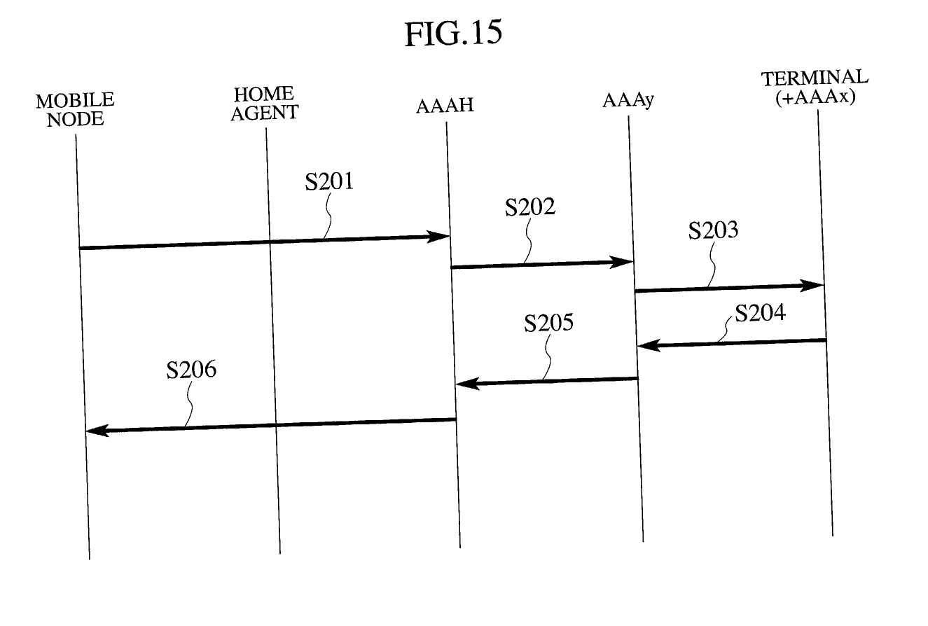

Next, with references to FIG. 14 and FIG. 15, one example (accounting information acquisition service) of the authentication and accounting service and the authentication and accounting request/response will be described. FIG. 14 shows a part related to the authentication and accounting service which is extracted from FIG. 1 (FIG. 14 shows the case where the request is made from the mobile node 1010 to the AAAH server 1012 without using the AAAF server 1022). FIG. 15 shows an exemplary procedure for the authentication and accounting service.

FIG. 14 is an example in which the accounting information is present at the terminal 1030, the mobile node 1010 requests the sending of the accounting information (information regarding the charge for purchased goods) to the terminal 1030, and the accounting information is sent from the terminal 1030 to the mobile node 1010.

First, the mobile node 1010 requests (by using a request packet) the acquisition of the accounting information to the AAAH server 1012 in order to acquire the accounting information (step S201).

It is also possible for the mobile node 1010 to request the sending of the accounting information directly to the terminal 1030, but here it is assumed that the authentication and the encryption will be applied to the transfer of the accounting information, and in order to attach the authentication data and apply the encryption with respect to the accounting information, there is a need to share a secret key in advance or exchange a public key between the mobile node 1010 and the terminal 1030. This can be realized by using IKE (Internet Key Exchange, RFC 2409) or ISAKMP (Internet Security Association and Key Management Protocol, RFC 2408). However, in this example, in order to minimize the functions of the mobile node 1010, it is assumed that the mobile node 1010 does not have a function for the key exchange protocol such as IKE.

The mobile node 1010 and the AAAH server 1012 can share a secret key or public key in advance, so that by using this key and IPSec (IP Security, RFC 2401-2405), it is possible to attach the authentication data or apply the encryption with respect to the communications between the mobile node 1010 and the AAAH server 1012 so that the secure data communications can be carried out.

Next, the AAAH server 1012 requests (by using a request packet) the sending of the accounting information to the AAAy server 1032 (step S202).

It is also possible for the AAAH server 1012 to request the sending of the accounting information directly to the terminal 1030, but here it is assumed that the request is made via the AAAy server 1032, so that the AAAH server 1012 requests the sending of the accounting information to the AAAy server 1032. Even for this request packet, in order to attach the authentication data or apply the encryption, the AAAH server 1012 first exchanges a secret key or a public key with the AAAy server 1032 by using IKE or the like and carries out the secure data communications by using the acquired key and IPsec.

Next, when the AAAy server 1032 receives the accounting information sending request packet, the AAAy server 1032 transfers this sending request packet to the terminal 1030 (step S203).

As for the data transfer between the AAAy server 1032 and the terminal 1030, a secret key or a public key may be exchanged dynamically by using IKE or the like, but it is also possible to share a secret key or a public key between the AAAy server 1032 and the terminal 1030 in advance, so that it is assumed here that the data communications are carried out by attaching the authentication data and applying the encryption by using the secret key or the public key shared in advance and IPSec.

Next, when the terminal 1030 receives the accounting information sending request packet, the terminal 1030 transfers a packet for the corresponding accounting information to the AAAy server 1032 (step S204).

In this data transfer, the secure data communications can be carried out by attaching the authentication data and applying the encryption by using the secret key or the public key shared in advance and IPSec, similarly as described above.

Next, when the AAAy server 1032 receives the accounting information packet from the terminal 1030, the AAAy server 1032 transfers this accounting information packet to the AAAH server 1012 (step S205).

In this data transfer, the secret key or the public key obtained at a time of the data transfer of the step S202 described above may be used, or the exchange of the secret key or the public key may be newly carried out dynamically by using IKE or the like, and the authentication data can be attached and the encryption can be applied by using the obtained key and IPSec.

Then, the AAAH server 1012 transfers the received accounting information packet to the mobile node 1010 (step S206).

For this data transfer, the secure data transfer can be carried out by using the secret key or the public key that is shared between the mobile node 1010 and the AAAH server 1012 in advance as described above.

Note that the accounting information may be present at the AAAy server 1032 corresponding to the terminal 1030. In this case, for example, the steps S203 and S204 may be skipped, or the providing of the accounting information to the terminal 1030 may be notified from the AAAy server 1032 to the terminal 1030.

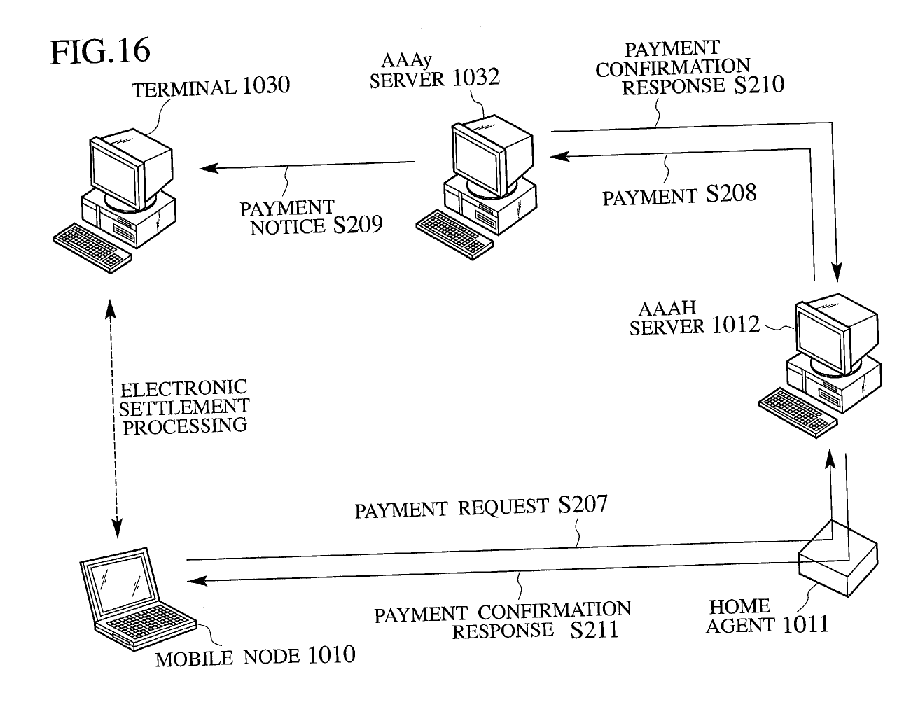

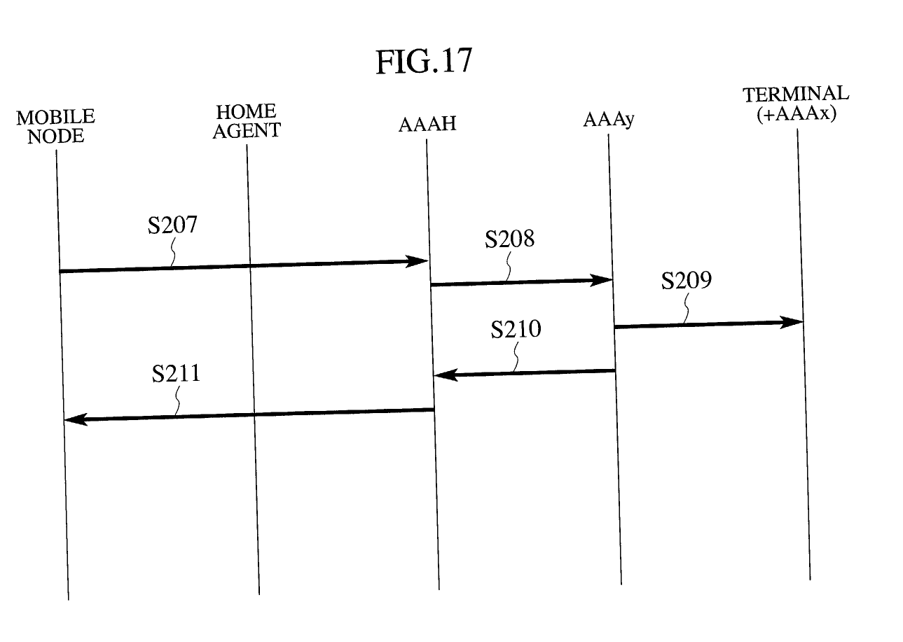

Next, with references to FIG. 16 and FIG. 17, another example (settlement processing service) of the authentication and accounting service and the authentication and accounting request/response will be described. FIG. 16 shows a part related to the authentication and accounting service which is extracted from FIG. 1 (FIG. 16 shows the case where the request is made from the mobile node 1010 to the AAAH server 1012 without using the AAAF server 1022). FIG. 17 shows another exemplary processing procedure for the authentication and accounting service.

FIG. 16 is directed to the exemplary case where the processing for the payment is to be carried out with the AAAy server 1032 (the terminal 1030 is located at the shop and the AAAy server 1032 is located at the credit company, for example), in which the payment is made from the mobile node 1010 to the AAAy server 1032 according to the accounting information, the payment notice is notified to the terminal 1030, and the payment confirmation information is sent to the mobile node 1010.

First, the mobile node sends a payment request (by using a request packet) to the AAAH server 1012, in order to carry out the electronic settlement from the AAAH server 1012 to the AAAy server 1032, according to the accounting information obtained by the step S206 described above, for example (step S207).

As described above, the secure data transfer can be carried out by attaching the authentication data and applying the encryption by using the secret key or the public key shared between the mobile node 1010 and the AAAH server 1012 in advance and IPSec.

Next, when the AAAH server 1012 receives the payment request packet from the mobile node 1010, the AAAH server 1012 carries out the electronic settlement with respect to the corresponding AAAy server 1032. For example, the necessary information is recorded into the account database memory unit 1202.

Then, the AAAH server 1012 transmits a packet for information regarding the payment to the AAAy server 1032 (step S208).

In this data transfer, the exchange of the secret key or the public key may be carried out dynamically by using IKE or the like, or the secret key or the public key obtained at the step S202 or S205 described above may be used, and the secure data transfer can be carried out by attaching the authentication data and applying the encryption by using the obtained key and IPSec.

Next, when the AAAy server 1032 receives the information regarding the payment from the AAAH server 1012, the AAAy server 1032 transmits a packet for notifying the payment with respect to the terminal 1030 (step S209).

In this data transfer, the exchange of the secret key or the public key may be carried out dynamically by using IKE or the like, or the key obtained at the step S203 described above may be used, or the secret key or the public key shared between the AAAy server 1032 and the terminal 1030 in advance may be used, and the secure data transfer can be carried out by attaching the authentication data and applying the encryption by using the appropriate key and IPSec.

At the same time, the AAAy server 1032 transmits a payment confirmation response packet to the AAAH server 1012 8step S210). In this data transfer, the exchange of the secret key or the public key may be carried out dynamically by using IKE or the like, or the key obtained at the step S205 described above may be used, and the secure data transfer can be carried out by attaching the authentication data and applying the encryption by using the appropriate key and IPSec.

Then, when the AAAH server 1012 receives the payment confirmation response packet from the AAAy server 1032, the AAAH server 1012 transfers this payment confirmation response packet to the mobile node 1010 (step S211).

In this data transfer, the secure data transfer can be carried out by attaching the authentication data and applying the encryption by using the secret key or the public key shared between the AAAH server 1012 and the mobile node 1010 in advance and IPSec.

Note that there are various methods for the payment of the fee to the user of the terminal 1030, including: (1) the method in which, when the charge of ¥(+X) is recorded with respect to the user of the mobile node 1010 at the account database memory unit 1202 of the AAAH server 1012, the charge of ¥(−X) is recorded with respect to the user of the terminal 1030 at the account database memory unit (not shown) of the AAAy server 1032 (when the charged amount becomes a positive value, it is collected as the communication fee, but when the charged amount becomes a negative value, the payment is made), and (2) the method in which, when the charge of ¥(+X) is recorded with respect to the user of the mobile node 1010 at the account database memory unit 1202 of the AAAH server 1012, the account database memory unit (not shown) of the AAAy server 1032 is not utilized and the payment of ¥X with respect to the user of the terminal 1030 is made outside the system on behalf of the mobile node 1010, for example.

Next, when the AAAH server 1012 receives the payment request packet from the mobile node 1010, the AAAH server 1012 carries out the electronic settlement with respect to the corresponding AAAy server 1032. For example, the necessary information is recorded into the account database memory unit 1202.

Also, there can be cases where the payment processing is to be carried out between the mobile node 1010 and the terminal 1030 (the cases where the terminal 1030 has the AAA function). In this case, the payment request rather than the payment notice is given from the AAAH server 1012 to the terminal 1030, the settlement processing is carried out at the terminal 1030 rather than at the AAAH server 1012, and the payment confirmation response packet is given from the terminal 1030 to the AAAH server 1012.

Apart from the two exemplary cases descried above, there are many possible variations for the authentication and accounting service and the authentication and accounting request/response.

For example, it is possible to modify the above such that, after sending the payment request from the mobile node 1010 to the AAAH server 1012 at the step S207, the AAAH server 1012 sends the confirmation request to the mobile node 1010 before carrying out the settlement processing, the mobile node 1010 displays a comment for confirming OK or cancel, and an affirmative response if the user entered OK or a negative response if the user entered cancel is returned to the AAAH server 1012, and the AAAH server 1012 carries out the settlement processing only when the affirmative response is received.

Also, in the case where the user of the mobile node 1010 has a right for cancellation or the like with respect to the provider of the terminal 1030 and this cancellation or the like is supported by the system, even after the payment processing is completed, it is possible to request the cancellation of the payment processing from the mobile node 1010, carry out the cancellation processing at the AAAH server 1012, and carry out the processing for notifying from the AAAy server 1032 to the terminal 1030, by the procedure similar to that of FIG. 16.

Note that the example of FIG. 1 is directed to the case where the terminal 1030 is a fixed terminal, the home network of the mobile node 1010 and the network to which the terminal 1030 belongs are different, and the mobile node 1010 moves to a network different from the network to which the terminal 1030 belongs, but the other cases are also of course possible.

For example, when the mobile node 1010 moves to the network to which the terminal 1030 belongs, there are cases where the AAAF server and the AAAy server are the same server (there are also cases where they are different servers).

Also, when the home network of the mobile node 1010 and the network to which the terminal 1030 belongs are the same, there are cases where the AAAH server and the AAAy server are the same server (there are also cases where they are different servers).

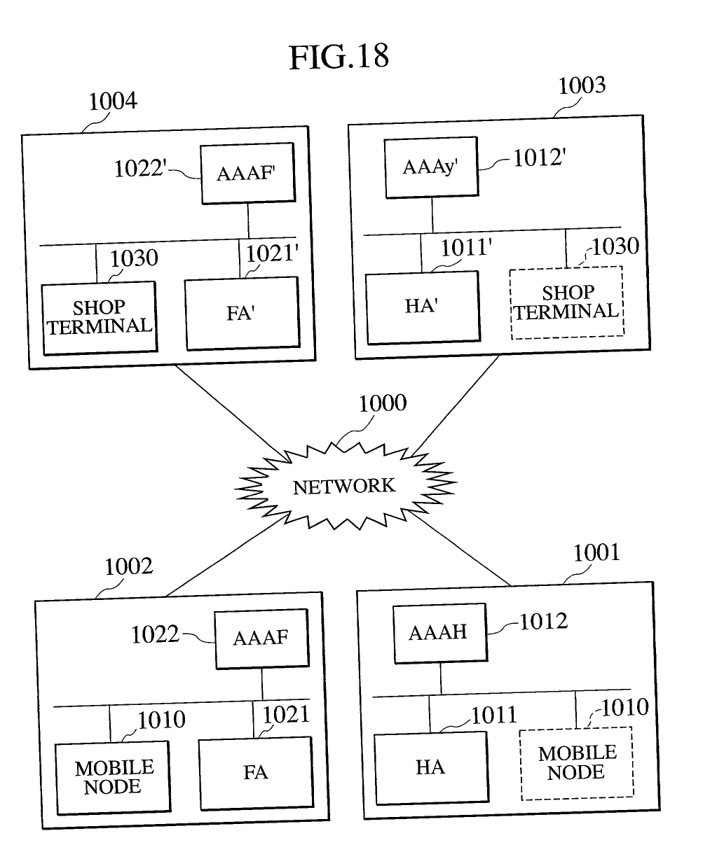

Also, when the terminal 1030 is also a mobile node, the network configuration becomes as shown in FIG. 18, for example. In this case, the operations of each device corresponding to the terminal 1030 is basically the same as each device corresponding to the mobile node 1010.

There are also cases where the mobile node 1010 and the terminal 1030 move to the same subnet such that both the mobile node 1010 and the terminal 1030 become the processing targets of the foreign agent and the AAAF server of that subnet.

There are also cases where the terminal 1030 moves to the home network of the mobile node 1010, such that the AAAF server with respect to the mobile node 1010 and the AAAH server with respect to the terminal 1030 are the same server (there are also cases where they are different servers).

There are also cases where the home network of the mobile node 1010 and the home network of the terminal 1030 are the same network.

Also, in the subnet in which the home agent and the foreign agent are to be provided, there are cases where the home agent and the foreign agent are the same server and there are cases where they are independent different servers.

According to this embodiment, in the case of the credit payment of the charge for goods purchased by the user, for example, it is possible to request the authentication and accounting processes with respect to the AAA function (AAAH) on the home network, for example, by using the AAA function (AAAM) on the mobile node, and it is possible to carry out the charge payment processing with respect to the desired AAA function from the AAA function (AAAH) on the home network, so that the mobile node can be used as a credit card.

Note that the exemplary case of applying the present invention to the processing regarding the electronic settlement has been described above, but the present invention is applicable to various other processings. In the following, the other examples will be listed.

* It is possible to display the communication accounting information managed within the AAAH server by using the AAA function on the mobile node.

* It is possible to provide a communication fee payment agent service by a third party (a service in which the mobile node sends a first request to an advertisement sponsor, and when the viewing of the advertisement is finished on the mobile node, the advertisement sponsor returns a response, and the advertisement sponsor pays a part or a whole of the fee for the next communication to be carried out by the mobile node as a reward for the viewing of the advertisement, for example).

* It is possible to realize the credit communication (a service in which the mobile node sends a first request to a credit company or the like, and when the customer authentication is success, the fee for the next communication to be carried out by the mobile node is settled by the credit company or the like on behalf of the mobile node, for example).

According to the first embodiment, it becomes possible for the mobile node devices according to the Mobile IP protocol to utilize the authentication and accounting services provided by AAA servers according to a prescribed AAA protocol for various purposes.

(Second Embodiment)

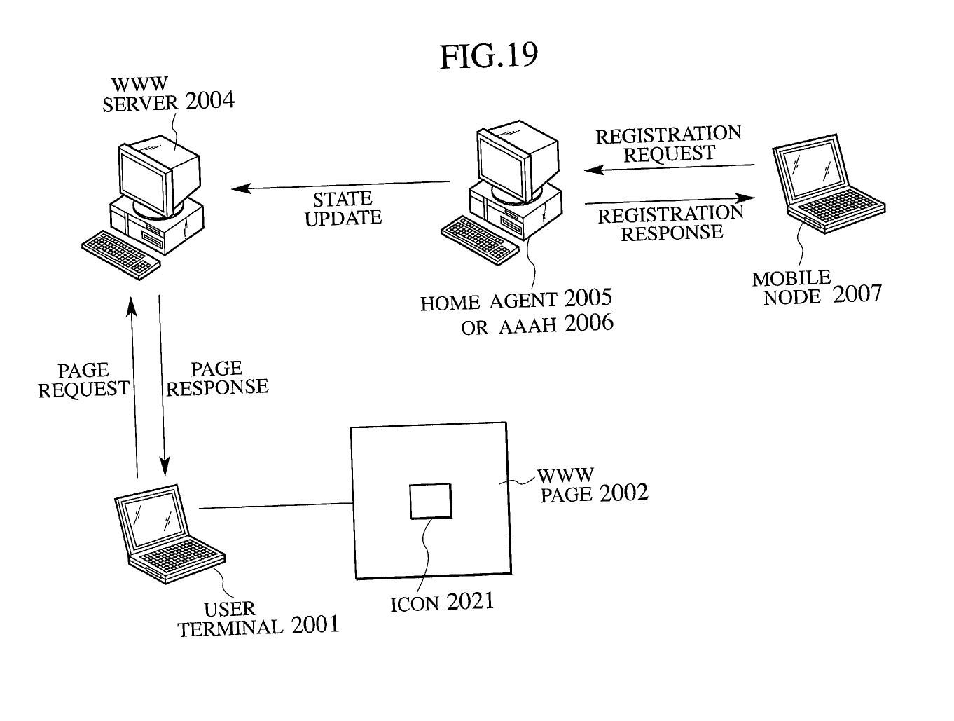

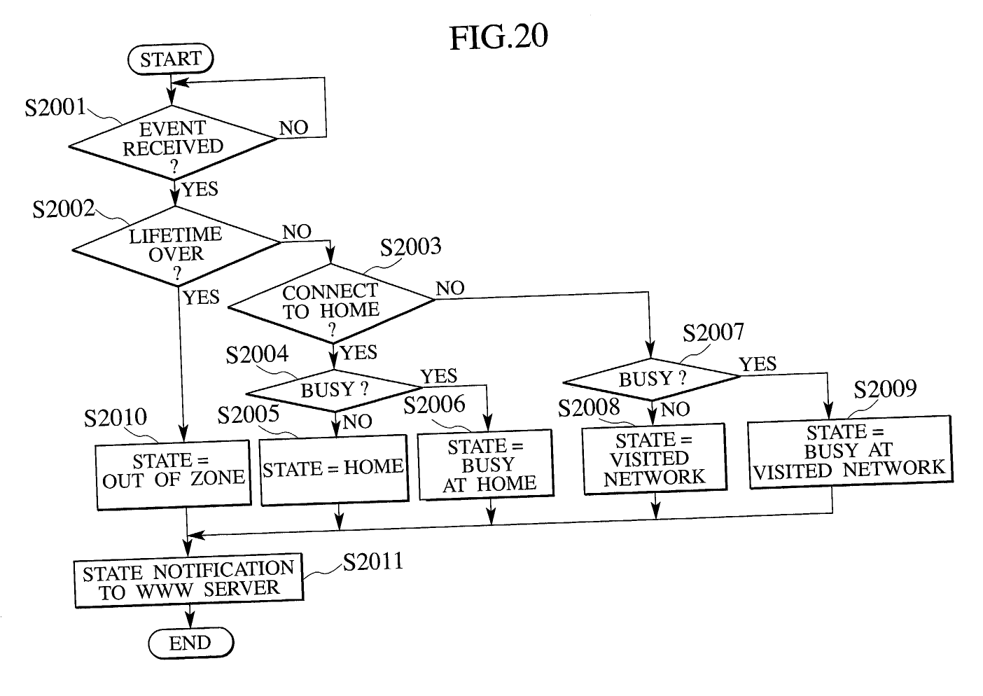

Next, with references to FIG. 19 and FIG. 20, the second embodiment of a mobile communication system according to the present invention will be described in detail.

FIG. 19 shows an exemplary configuration of a Mobile IP telephone system according to the second embodiment.

In this Mobile IP telephone system of FIG. 19, an icon 2021 is provided in a WWW page 2002 displayed on a user terminal 2001, and the URL of this icon 2021 is registered in advance as:

sipp://host.network.com, or

h323p://host.network.com, fpr example.

When the icon 2021 is specified (by the clicking or the double clicking, for example) by the user of the user terminal 2001, a call control program using SIP (Session Initiation Protocol, RFC 2543) or ITU-T H.323 for example is activated on the user terminal 2001 at this timing, and a call setup request packet for making an IP telephone call is transmitted to the IP terminal having the host name of “host.network.com” in this example. By using the IP telephone, it is possible to have conversations by using the IP telephone while viewing the WWW page.

For the Mobile IP terminal using the Mobile IP, the URL containing the host name, the IP address, the NAI (Network Access Identifier) or the like of the Mobile IP terminal is registered in advance for the icon 2021. In this case, the user who views the WWW page 2002 containing such an icon 2021 clicks the icon 2021, for example, the call setup request packet is transferred to the home IP address in the home network of the Mobile IP terminal, and thereafter, the call setup request packet is transferred to the mobile node by the Mobile IP function, regardless of whether the mobile node is located at the home network or at the visited network, so that it is possible to carry out the call control processing of the IP telephone with respect to this mobile node.

Of course, the WWW page 2002 can be provided as many as the number of terminals to be registered. Also, the icon 2021 to be displayed in one WWW page 2002 can be provided as many as the number of terminals to be registered. Also, information regarding the user of the corresponding terminal (for example, an image of a face or the like of the user, a video showing the user, a still picture or video image of something other than the user, text information, etc.) can be displayed on the icon 2021.

Now, it is inconvenient if the state of the mobile node cannot be ascertained by just viewing the icon on the WWW page and the state of the mobile node cannot be ascertained unless the IP telephone call is actually made. For example, when the mobile node is not connected to any network or when the power of the mobile node is turned off, the IP telephone call to the mobile node from the user terminal will inevitably fails, but it is inconvenient if such a state can be ascertained only by actually making the IP telephone call.

For this reason, this embodiment is devised such that the state of the mobile node can be ascertained by just viewing the icon 2021 on the WWW page 2002. In this embodiment, in the case where the AAA protocol is not adopted, this function is realized by utilizing the home agent 2005. In the case where the AAA protocol is adopted, this function is realized by utilizing the AAAH (AAA Home) server 2006 for the initial registration request after the mobile node has moved and the home agent 2005 for the subsequent registration request for updating the registration.

FIG. 20 shows an exemplary processing procedure of the home agent 2005 or the AAAH server 2006 in this case.

When the registration request is received from the mobile node 2007 of the Mobile IP (step S2001), the home agent 2005 or the AAAH server 2006 checks the received registration request, and if the request is acceptable, the home agent 2005 or the AAAH server 2006 updates the management information for the corresponding mobile node 2007, returns the registration response packet to the mobile node 2007, and notifies the state information of the updated mobile node 2007 to the WWW server 2004 registered in advance (step S2011).

This notified state information includes a state in which the mobile node 2007 is located at the home network (step S2003 YES), a state in which the mobile node is located at a visited network (step S2003 NO), etc.

Also, in the case where the mobile node is located at the visited network according to the Mobile IP protocol, the life time is notified, and when the registration request for updating is received within the life time (step S2002 NO), the home agent 2005 or the AAAH server 2006 regards that the mobile node 2007 is located at the same visited network, whereas when the registration request for updating is not received within the life time (step S2002 YES), the home agent 2005 or the AAAH server 2006 judges that the mobile node 2007 has left the IP network (step S2010), and the state of the mobile node is notified to the WWW server 2004 as “out of zone”.

Also, when it is possible to sent the state information indicating busy when the user on the mobile node 2007 is busy on the IP telephone, by using the new extension function of the Mobile IP protocol such as vendor extension or the like, the state information indicating “busy” (step S2006 or step S2009) if the mobile node 2007 is busy (step S2004 YES or step S2007 YES), or the state information indicating “not busy” (step S2005 or step S2008) if the mobile node 2007 is not busy (step S2004 NO or step S2007 NO) can be notified distinguishably from the home agent 2005 or the AAAH server 2006 to the WWW server 2004 registered in advance.

Upon receiving the state information of the mobile node 2007 such as “home”, “visited network”, “out of zone”, “busy”, etc., the WWW server 2004 changes a shape or the like of the corresponding icon 2021 on the corresponding WWW page 2002 to a shape or the like that is registered in correspondence to each state in advance, such that the user of the terminal other than the mobile node 2007 can ascertain the state f the mobile node 2007 by downloading the corresponding WWW page 2004 and viewing the shape or the like of the icon 2021 on the WWW page 2002.

In the above described example, the exemplary case where the home agent 2005 or the AAAH server 2006 notifies the state information of the mobile node 2007 to the WWW server 2004 registered in advance has been described, but of course the other methods are also possible. For example, it is possible to set the image storing location of all or a part of the icons 2021 on the corresponding WWW page 2002 as the corresponding home agent 2005 or the corresponding AAAH server 2006. Then, at a time of downloading the WWW page 2002, the image files will be transferred for the corresponding icons 2021, from the home agent 2005 or the AAAH server 2006 rather than from the WWW server 2004, so that means for notifying the state information of the mobile node 2007 from the home agent 2005 or the AAAH server 2006 to the WWW server 2004 can be omitted.

Also, in the above described example, the exemplary case where the shape or the like of the icon corresponding to the state of the mobile node 2007 is transmitted at a time of downloading the WWW page 2002 has been described, but of course the other methods are also possible. For example, by downloading the image file of the icon 2021 on the WWW page 20902 again at a constant time interval, or by sending the image file of the corresponding icon 2021 when the state of the mobile node 2007 is updated, it is possible to eliminate a need to carry out the procedure for changing the shape of the icon to the shape corresponding to the updated state of the mobile node 2007 by downloading the WWW page 2002 again whenever the state of the mobile node 2007 changes.

Note that the above described example has an aim of notifying the state information of the mobile node to the other users by assuming the application in a form of the IP telephone, but the method of the present invention is also applicable to the packet transfer or the other applications. For example, the method of the present invention is applicable to a management program for managing the state of the mobile node or a management program for managing the seating states members belonging to a virtual office.

According to the second embodiment, the user can ascertain the state of the desired correspondent by viewing the shape of the icon on the corresponding WWW page, for example, such that when the correspondent terminal is not connected to the network, this fact can be ascertained by viewing the shape of the icon, and therefore there is an advantage that the time and effort required in actually making the telephone call for the purpose of ascertaining the state of the correspondent terminal can be eliminated.

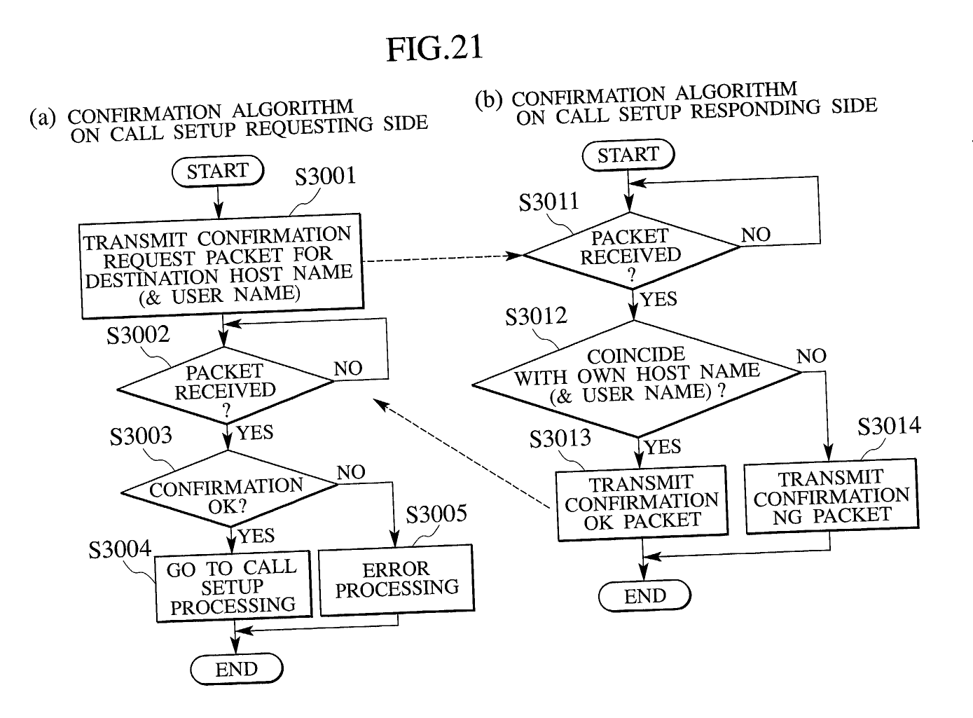

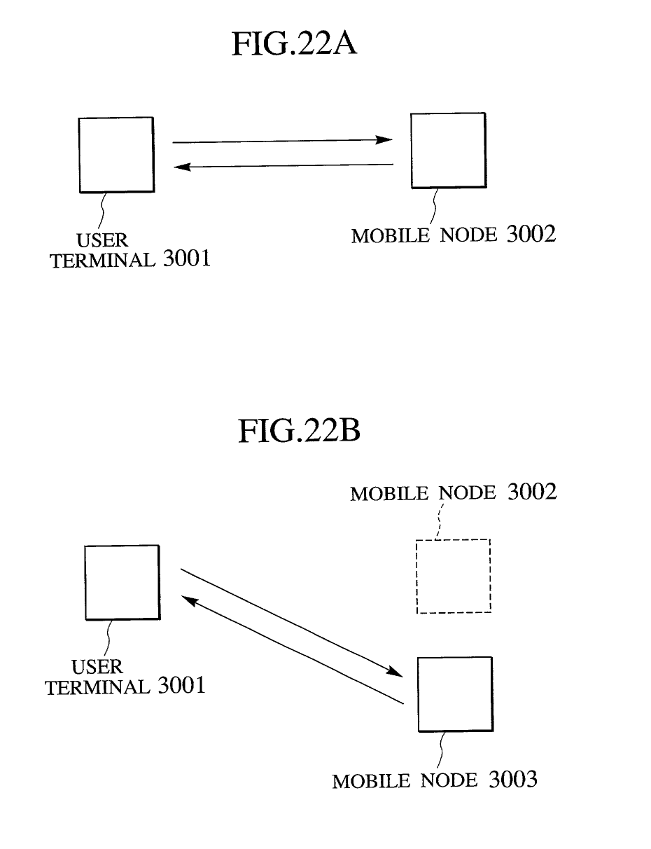

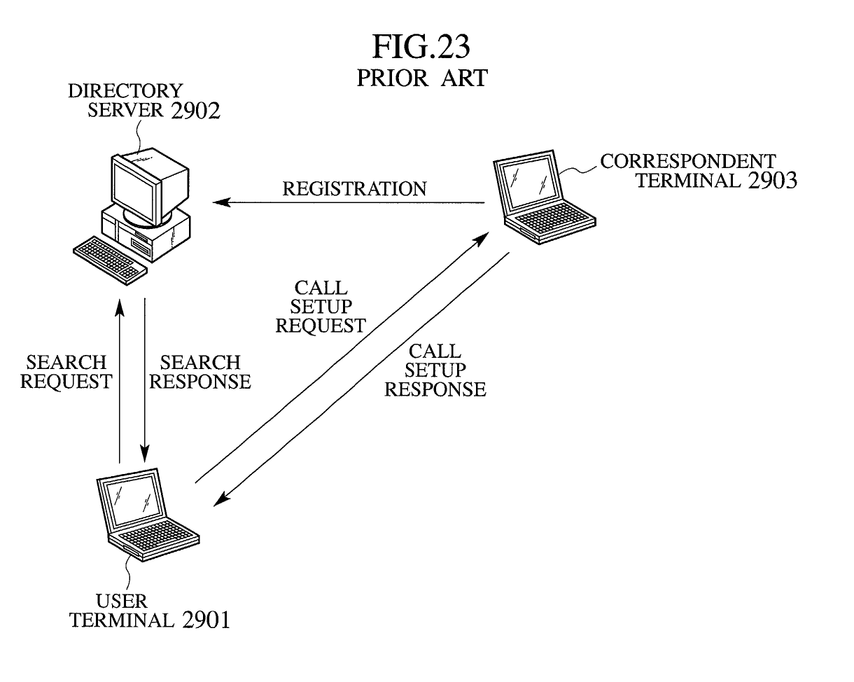

Referring now to FIG. 21 and FIG. 22, the third embodiment of a mobile communication system according to the present invention will be described in detail.

A part (a) of FIG. 21 shows an exemplary processing procedure (a confirmation algorithm at a time of call setup) of the terminal which is a source in this embodiment, and a part (b) of FIG. 21 shows an exemplary processing procedure (a confirmation algorithm at a time of call setup) of the terminal which is a correspondent (destination) in this embodiment.

Before transmitting the call setup request of the IP telephone to the terminal of the IP address acquired as that of the desired terminal (or the desired terminal and user), the source terminal transmits a confirmation request packet for confirming the host name (or the home name and the user name) of the destination terminal to the terminal of that IP address, in order to check whether the terminal (or the terminal and user) of that IP address actually coincides with the desired terminal (or the desired terminal and user) or not (step S3001).

The terminal that received this confirmation request packet (step S3011) checks whether the host name (or the home name and the user name) contained in the confirmation request packet coincides with the host name (or the host name and the user name of the user who is using that terminal at that timing) of that terminal or not. If they coincide (step S3012 YES), a confirmation OK packet is returned (step S3013), whereas if they do not coincide (step S3012 NO), a confirmation NG packet is returned (step S3014).

The source terminal that received a response packet corresponding to the confirmation request packet (step S3002) checks whether the response packet is the confirmation OK packet or the confirmation NG packet, and if it is the confirmation OK packet (step S3003 YES), the processing proceeds to the call setup procedure for making the IP telephone call (step S3004), whereas if it is the confirmation NG packet (step S3003 NO), the processing does not proceed to the call setup procedure and the error processing is executed (step S3005).

When the correspondent is actually the desired mobile node (mobile node according to the Mobile IP protocol) 3002 (which is assumed to have the host name=A and the user name=X) as shown in FIG. 22A, for example, the user terminal 3001 transmits the confirmation request packet containing the host name=A and the user name=X to the mobile node 3002. The mobile node 3002 that received this confirmation request packet compares the host name=A and the user name=X contained in this confirmation request packet with the host name=A and the user name=X of the own terminal, and as they coincide, the mobile node 3002 returns the confirmation OK packet. The user terminal 3001 that received this confirmation OK packet then proceeds to the call setup procedure for making the IP telephone call.

Also, when the correspondent is a mobile node 3003 (which is assumed to have the host name=B and the user name=Y) different from the mobile node 3002 as the desired mobile node 3002 of the user terminal 3001 has already moved as shown in FIG. 22B, for example, the user terminal 3001 transmits the confirmation request packet containing the host name=A and the user name=X to the mobile node 3003. The mobile node 3003 that received this confirmation request packet compares the host name=A and the user name=X contained in this confirmation request packet with the host name=B and the user name=Y of the own terminal, and as they do not coincide, the mobile node 3003 returns the confirmation NG packet. The user terminal 3001 that received this confirmation NG packet then executes the error processing.

In general, the destination of the IP telephone can be given by the NAI (Network Access Identifier) that contains the IP address, the host name, or the host name and the user name. However, in the case where the destination terminal acquired the IP address by DHCP, the IP address is inappropriate as information for confirming the destination. Also, in the case where there are a plurality of users who are using the correspondent terminal, information such as the NAI containing the user name is preferable as information for confirming the correspondent.

Also, as described above, the processing proceeds to the call setup procedure after confirming the correspondent, but there can be a case where the mobile node moves during the call setup procedure, so that it is preferable to enter the identification information for confirming the correspondent even in the packet during the call setup procedure in the system where this case can cause a trouble. As an example of this case, the ID number can be entered into the above described confirmation request packet of the confirmation OK packet, the same ID number can be used for the subsequent call setup procedure packet, and this ID number can be checked at the receiving terminal side so as to guarantee that it is the call setup procedure with the terminal that is confirmed to be the desired terminal.

Also, in the above described example, the exemplary case of checking the host name (or the host name and the user name) as the confirmation information has been described, but it is also possible to carry out the authentication of the correspondent terminal or the user by using the public key information or the certificate authority in addition.

Note that the above described example has an aim of notifying the state information of the mobile node to the other users by assuming the application in a form of the IP telephone, but the method of the present invention is also applicable to the packet transfer or the other applications.

According to the third embodiment, whether the correspondent terminal is actually the desired terminal or not is checked by using the host name (and the user name) before carrying out the call setup procedure, so that it is possible to prevent the conventionally encountered problem where the correspondent terminal is a mobile node that has already moved and the call setup procedure is carried out with respect to a wrong terminal that just happened to be using the same IP address at a time.

It is to be noted that the above described embodiments according to the present invention may be conveniently implemented using a conventional general purpose digital computer programmed according to the teachings of the present specification, as will be apparent to those skilled in the computer art. Appropriate software coding can readily be prepared by skilled programmers based on the teachings of the present disclosure, as will be apparent to those skilled in the software art.

In particular, each one of the mobile node and the AAAH server of the first embodiment can be conveniently implemented in a form of a software package.

Such a software package can be a computer program product which employs a storage medium including stored computer code which is used to program a computer to perform the disclosed function and process of the present invention. The storage medium may include, but is not limited to, any type of conventional floppy disks, optical disks, CD-ROMs, magneto-optical disks, ROMs, RAMs, EPROMs, EEPROMs, magnetic or optical cards, or any other suitable media for storing electronic instructions.

It is also to be noted that, besides those already mentioned above, many modifications and variations of the above embodiments may be made without departing from the novel and advantageous features of the present invention. Accordingly, all such modifications and variations are intended to be included within the scope of the appended claims.

What is claimed is:

1. A mobile communication system, comprising:
a mobile node device according to Mobile IP protocol;
an AAAH server device according to a prescribed AAA protocol which is provided at a home network of the mobile node device, for supporting an authentication and accounting service with respect to packet communications by the mobile node device;
the mobile node device having a transmission unit configured to transmit an authentication and accounting request for requesting a desired accounting service at the AAAH server device; and
the AAAH server device having:
an information recording unit configured to record communication fee information regarding a communication fee to be charged to a user of the mobile node device; and
a processing unit configured to carry out authentication and accounting processes for the packet communications by the mobile node device according to the communication fee information, and a processing for providing the desired accounting service according to the authentication and accounting request which is received from the mobile node device when it is judged that authentication succeeded according to authentication information contained in the authentication and accounting request.

2. The mobile communication system of claim 1, wherein the processing unit of the AAAH server device is operated such that, when the desired accounting service is a processing for transferring a charged amount to be paid to another party by the user of the mobile node device to the communication fee of the user of the mobile node device, the communication fee information is recorded in the information recording unit according to the charged amount.

3. The mobile communication system of claim 2, wherein the processing unit also carries out a procedure for paying the charged amount to said another party when the desired accounting service is a payment of the charged amount to said another party.

4. The mobile communication system of claim 2, wherein the processing unit of the AAAH server device is operated such that, when the desired accounting service is the processing for transferring the charged amount to be paid to said another party by the user of the mobile node device to the communication fee of the user of the mobile node device, the processing unit notifies information regarding the authentication and accounting request from the mobile node device to another AAA server device for supporting the authentication and accounting service with respect to a mobile node of said another party.

5. The mobile communication system of claim 2, wherein the processing unit of the AAAH server device is operated such that, when the desired accounting service is acquisition of a charged amount information regarding the charged amount to be paid to said another party by the user of the mobile node device, the processing unit acquires the charged amount information from a device providing the charged amount information and transfers the charged amount information to the mobile node device.

6. The mobile communication system of claim 1, further comprising:
an AAAF server device according to the prescribed AAA protocol which is provided at a visited network of the mobile node device, for supporting the authentication and accounting service with respect to packet communications by the mobile node device, the AAAF server device having a transmission unit configured to transmit another authentication and accounting request for requesting an accounting with respect to the packet communications by the mobile node device that has moved to the visited network;
wherein the processing unit of the AAAH server device is operated such that, when said another authentication and accounting request is received from the AAAF server device and it is judged that authentication succeeded according to an authentication information contained in said another authentication and accounting request, the communication fee information is recorded in the information recording unit according to information regarding the accounting contained in said another authentication and accounting request.

7. A mobile node device according to Mobile IP protocol, comprising:
a Mobile IP processing unit configured to carry out a procedure for receiving a packet transfer service according to the Mobile IP by a home agent device provided at a home network of the mobile node device and a foreign agent device provided at a visited network of the mobile node device; and
an AAA processing unit configured to carry out a procedure for receiving a desired accounting service, with respect to an AAAH server device according to a prescribed AAA protocol which is provided at the home network for managing information regarding a communication fee of the mobile node device, while receiving the packet transfer service at the Mobile IP processing unit.

8. The mobile node device of claim 7, wherein the AAA processing unit carries out a procedure for requesting transfer of a charged amount to be paid to another party by a user of the mobile node device to the communication fee of the user of the mobile node device.

9. The mobile node device of claim 8, wherein the processing unit carries out a procedure for requesting payment of the charged amount to said another party.

10. The mobile node device of claim 8, wherein the processing unit carries out a procedure for requesting acquisition of a charged amount information regarding the charged amount to be paid to said another party by the user of the mobile node device.

11. An AAAH server device according to a prescribed AAA protocol which is provided at a home network of a mobile node device according to Mobile IP protocol in a mobile communication system, for supporting an authentication and accounting service with respect to packet communications by the mobile node device, the AAAH server device comprising:
an information recording unit configured to record communication fee information regarding a communication fee to be charged to a user of the mobile node device; and
a processing unit configured to carry out authentication and accounting processes for the packet communications by the mobile node device according to the communication fee information, and a procedure for providing a desired accounting service according to an authentication and accounting request which is received from the mobile node device when it is judged that authentication succeeded according to authentication information contained in the authentication and accounting request.

12. The AAAH server device of claim 11, wherein the processing unit is operated such that, when the desired accounting service is a processing for transferring a charged amount to be paid to another party by the user of the mobile node device to the communication fee of the user of the mobile node device, the communication fee information is recorded in the information recording unit according to the charged amount.

13. The AAAH server device of claim 12, wherein the processing unit also carries out a procedure for paying the charged amount to said another party when the desired accounting service is a payment of the charged amount to said another party.

14. The AAAH server device of claim 12, wherein the processing unit is operated such that, when the desired accounting service is the processing for transferring the charged amount to be paid to said another party by the user of the mobile node device to the communication fee of the user of the mobile node device, the processing unit notifies information regarding the authentication and accounting request from the mobile node device to another AAA server device for supporting the authentication and accounting service with respect to a mobile node of said another party.

15. The AAAH server device of claim 12, wherein the processing unit is operated such that, when the desired accounting service is acquisition of a charged amount information regarding the charged amount to be paid to said another party by the user of the mobile node device, the processing unit acquires the charged amount information from a device providing the charged amount information and transfers the charged amount information to the mobile node device.

16. The AAAH server device of claim 11, wherein the mobile communication system has an AAAF server device according to the prescribed AAA protocol which is provided at a visited network of the mobile node device, for supporting the authentication and accounting service with respect to packet communications by the mobile node device and transmitting another authentication and accounting request for requesting an accounting with respect to the packet communications by the mobile node device that has moved to the visited network; and
the processing unit is operated such that, when said another authentication and accounting request is received from the AAAF server device and it is judged that authentication succeeded according to an authentication information contained in said another authentication and accounting request, the communication fee information is recorded in the information recording unit according to information regarding accounting contained in said another authentication and accounting request.

17. A method for receiving an authentication and accounting service at a mobile node device according to Mobile IP protocol, the method comprising:
carrying out a procedure for receiving a packet transfer service according to the Mobile IP by a home agent device provided at a home network of the mobile node device and a foreign agent device provided at a visited network of the mobile node device; and
carrying out a procedure for receiving a service of a desired accounting service, with respect to an AAAH server device according to a prescribed AAA protocol which is provided at the home network for managing information regarding a communication fee of the mobile node device, while receiving the packet transfer service.

18. A method for providing an authentication and accounting service at an AAAH server device according to a prescribed AAA protocol which is provided at a home network of a mobile node device according to Mobile IP protocol in a mobile communication system, for supporting an authentication and accounting service with respect to packet communications by the mobile node device, the method comprising:
recording communication fee information regarding a communication fee to be charged to a user of the mobile node device; and
carrying out authentication and accounting processes for the packet communications by the mobile node device according to the communication fee information, and a procedure for providing a desired accounting service according to an authentication and accounting request which is received from the mobile node device when it is judged that authentication succeeded according to authentication information contained in the authentication and accounting request.

19. A method for providing a mobile node device information, comprising:
notifying information indicating a state of a mobile node device according to Mobile IP protocol from a prescribed server device which detected the state of the mobile node device to a WWW server device for providing information of the mobile node device; and
updating a display format of a prescribed display content corresponding to the mobile node device to a new display format corresponding to a notified state at a WWW page corresponding to the mobile node device provided by the WWW server device upon receiving the information indicating the state of the mobile node device.

20. A method for confirming a correspondent terminal, comprising:
transmitting a confirmation request from a first terminal device to a second terminal device which is a mobile node device according to Mobile IP protocol, before carrying out a call setup procedure from the first terminal device with respect to the second terminal device, the confirmation request containing an identification information including a host name or a set of a host name and a user name of the second terminal device as recognized by the first terminal device;
comparing the identification information contained in the confirmation request with an actual identification information including an actual host name or a set of an actual host name and an actual user name of the second terminal device, at the second terminal device upon receiving the confirmation request, and returning an affirmative response when the identification information contained in the confirmation request coincides with the actual identification information of the second terminal device or a negative response when the identification information contained in the confirmation request does not coincide with the actual identification information of the second terminal device, from the second terminal device to the first terminal device; and
carrying out the call setup procedure from the first terminal device with respect to the second terminal device when the affirmative response from the second terminal device is received at the first terminal device.
